(19) United States
(12) Patent Application Publication
(10) Pub. No.: US 2009/0246421 A1
(43) Pub. Date: Oct. 1, 2009

(54) INKJET RECORDING MEDIUM AND METHOD OF PRODUCING THE SAME

(75) Inventor: Masamichi KOBAYASHI, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/411,923

(22) Filed: Mar. 26, 2009

(30) Foreign Application Priority Data
Mar. 31, 2008 (JP) 2008-094266
May 22, 2008 (JP) 2008-134847
Dec. 2, 2008 (JP) 2008-307836

(51) Int. Cl. B32B 33/00

(52) U.S. Cl. 428/32.24

(57) ABSTRACT

Disclosed is an inkjet recording medium having at least two ink-receiving layers on a substrate. At least one of the at least two ink-receiving layers contains a basic compound. Among the at least two ink-receiving layers, an uppermost layer that is the farthest from the substrate includes pseudoboehmite alumina, a binder, and a water-soluble high-boiling solvent, and a lower layer provided between the uppermost layer and the substrate includes inorganic fine particles, a binder, and a cationic polyurethane and/or a zirconium salt.

### CROSS-REFERENCE TO RELATED APPLICATION

This application is based on and claims priority under 35 USC 119 from Japanese Patent Application Nos. 2008-094266 filed on Mar. 31, 2008, 2008-134847 filed on May 22, 2008, and 2008-307836 filed on Dec. 2, 2008, the disclosures of which are incorporated herein by reference in their entirety.

### BACKGROUND OF THE INVENTION

1. Field of the Invention

The present invention relates to an inkjet recording medium and a method of producing the same.

2. Description of the Related Art

Following rapid progress in the field of information technology in recent years, information processing systems of various kinds have been developed and recording methods and recording devices suitable for each information processing system have been put to practical use. Among these, inkjet recording methods are widely used because recording is possible on recording media of various types, the hardware (devices) are comparatively inexpensive and compact, and a very low level of noise is generated. Furthermore, with recording using the inkjet recording medium, a recorded image of so-called “photo-like” quality can be obtained.

A recording medium for inkjet recording is typically required to have the following properties: (1) fast drying ability (high ink absorption rate); (2) appropriate and uniform dot diameter (no bleeding); (3) good graininess; (4) high roundness of dots; (5) high color density; (6) high color saturation (no dullness); (7) good water resistance, light resistance, and ozone resistance of the image portion; (8) high whiteness; (9) high storage stability (no yellowing discoloration or image bleeding in long-term storage); (10) resistance to deformation and good dimensional stability (low degree of curling); and (11) good hardware running ability.

In consideration of the above-described requirements, an inkjet recording medium in which a layer receiving an ink (ink-receiving layer) has a porous structure has been put to practical use and has been an object of various research in recent years.

For example, a feature of introducing a water-soluble polyvalent metal salt and an aqueous dispersion of a cation-modified polymer in the ink-receiving layer with the object of improving resistance to bleeding over time (see, for example, JP-A No. 2006-15655) and a feature of introducing an aqueous dispersion of a polymer with a glass transition temperature of equal to or less than 50° C. and an average particle size of equal to or less than 0.05 μm with the object of improving print density and reducing bleeding with the passage of time and brittleness (see, for example, JP-A No. 2006-264190) are known.

Furthermore, a feature of introducing alumina or an alumina hydrate into an ink-receiving layer with the object of improving bronzing and increasing the absorption rate, water resistance, and coloring ability is known, wherein an average secondary particle size of the alumina or alumina hydrate is 80-300 nm, an average primary particle size is 3-50 nm, and the probability of presence of a particle in a primary particle state is equal to or less than 10% (see, for example, JP-A No. 2005-254588).

A feature of introducing an alumina hydrate into an upper layer of an ink-receiving layer, without introducing a cationic compound other than alumina hydrate, and introducing fine particle silica, a water-soluble zirconium compound, and cationic polymer into a lower layer of the ink-receiving layer with the object of reducing bronzing and bleeding is also known (see, for example, JP-A No. 2005-262716).

### SUMMARY OF THE INVENTION

However, when the ink-receiving layers described in JP-A Nos. 2006-15655, 2006-264190, and 2005-254588 are used, print density sometimes decreases. When the ink-receiving layer described in JP-A No. 2005-262716 is used, in some cases, it is impossible both to increase the print density and to reduce bronzing.

The present invention was created with consideration for the above-described problems and it provides an inkjet recording medium and a method of producing the same.

According to the first aspect of the invention, there is provided an inkjet recording medium having at least two ink-receiving layers on a substrate; at least one of the at least two ink-receiving layers includes a basic compound; among the at least two ink-receiving layers, an uppermost layer that is the farthest from the substrate includes pseudoboehmite alumina, a binder, and a water-soluble high-boiling point solvent, and a lower layer provided between the uppermost layer and the substrate comprises inorganic fine particles, a binder, a cationic polyurethane and/or a zirconium salt.

In accordance with the invention, it is possible to provide an inkjet recording medium with excellent print density in which bleeding and bronzing can be inhibited and also a method of producing such an inkjet recording medium.

### DETAILED DESCRIPTION OF THE INVENTION

<<Inkjet Recording Medium>>

The inkjet recording medium in accordance with the present invention has at least two ink-receiving layers on a substrate; at least one of the at least two ink-receiving layers includes a basic compound; among the at least two ink-receiving layers, an uppermost layer that is the farthest from the substrate includes pseudoboehmite alumina, a binder, and a water-soluble high-boiling solvent, and a lower layer provided between the uppermost layer and the substrate comprises inorganic fine particles, a binder, and a cationic polyurethane and/or a zirconium salt.

Pseudoboehmite alumina is a component contributing to an increase in print density, but bronzing sometimes occurs in ink-receiving layers including pseudoboehmite alumina.

Adding a water-soluble high-boiling solvent and a basic compound to an ink-receiving layer including pseudoboehmite alumina is an effective method for inhibiting bronzing, but the addition of water-soluble high-boiling solvent deteriorates bleeding. Adding a cationic polyurethane or a zirconium salt is effective in inhibiting bleeding, but print density decreases when a cationic polyurethane or zirconium salt is added to an ink-receiving layer including pseudoboehmite alumina.

Thus, print density can be increased and at the same time bleeding can be inhibited by providing an ink-receiving layer in which a cationic polyurethane and/or a zirconium salt is present in a lower layer of the ink-receiving layer including pseudoboehmite alumina.

Therefore, by configuring an inkjet recording medium according to the invention, it is possible to increase print density and inhibit bleeding and bronzing.

Furthermore, when an ink-receiving layer has a single-layer configuration, more specifically, when a water-soluble high-boiling solvent and a cationic polyurethane are contained in the same ink-receiving layer, the ink-receiving layer sometimes shrinks during coating and drying and the layer formation becomes difficult (that is, suitability for coating decreases).

Therefore, the invention also provides good suitability for coating.

In accordance with the invention, the basic compound may be contained in at least one layer from among the at least two ink-receiving layers.

From the standpoint of obtaining the effect of the invention more effectively, it is preferred that the basic compound be contained in the uppermost layer.

<Ink-Receiving Layer>

The inkjet recording medium in accordance with the invention has at least two ink-receiving layers on a substrate.

The at least two ink-receiving layers are not particularly limited, provided that they include an uppermost layer that is the farthest from the substrate and a lower layer provided between the uppermost layer and the substrate. If necessary, another layer (intermediate layer or the like) may be contained between the uppermost layer and the lower layer, or between the lower layer and the substrate.

(Uppermost Layer)

The uppermost layer in accordance with the invention includes pseudoboehmite alumina, a binder, and a water-soluble high-boiling solvent. If necessary, the uppermost layer may contain other components. However, from the standpoint of further inhibiting the drying-induced shrinkage of the ink-receiving layer, it is preferred that the uppermost layer contain no below-described cationic polyurethane.

From the standpoint of obtaining the effect of the invention more effectively, it is further preferred that the uppermost layer in accordance with the invention include a basic compound.

The coating amount of the pseudoboehmite alumina of the uppermost layer is not particularly limited, but from the standpoint on ink absorption ability and coloring ability, it is preferred that this coating amount be 10-30 g/m², more preferably 15-25 g/m².

The aforementioned components contained in the uppermost layer will be described below in greater detail.

(Lower Layer)

The lower layer in accordance with the invention includes inorganic fine particles, a binder, and a cationic polyurethane and/or a zirconium salt. If necessary, the lower layer may contain other components. However, from the standpoint of further inhibiting the drying-induced shrinkage of the ink-receiving layer, it is preferred that the lower layer contain no below-described water-soluble high-boiling solvent.

The lower layer may have a single-layer configuration or may be configured of two or more layers.

The coating amount of the inorganic fine particles of the lower layer (in the case of two or more layers, the total coating amount) is not particularly limited, but from the standpoint of ink absorption ability and coating ability, this coating amount is preferably 9-30 g/m², more preferably 15-25 g/m².

The aforementioned components contained in the lower layer will be described below in greater detail.

In accordance with the invention, from the standpoint of obtaining the bronzing inhibition effect more effectively, it is preferred that the layer ratio (%) of the uppermost layer represented by Formula A below be adjusted.

Layer ratio (%) of uppermost layer=((Coating amount (weight) of pseudoboehmite alumina of the uppermost layer)/(Coating amount (weight) of pseudoboehmite alumina of the uppermost layer)+(Coating amount (weight) of inorganic fine particles of the lower layer))×100 Formula A.

More specifically, from the standpoint of obtaining the bronzing inhibition effect more effectively, it is preferred that the layer ratio (%) of the uppermost layer be equal to or more than 10%, more preferably equal to or more than 30%, and even more preferably equal to or more than 40%.

The upper limit of the layer ratio (%) of the uppermost layer is preferably 77%, more preferably 60%.

The components contained in the ink-receiving layer in accordance with the invention will be described below.

(Basic Compound)

At least one layer (preferably, the uppermost layer) among the ink-receiving layers in accordance with the invention includes a basic compound.

Examples of suitable basic compounds include alcoholamines such as ethanolamine and triethanolamine, volatile bases such as ammonia, inorganic alkali agents, for example, alkali metal hydroxides such as sodium hydroxide, potassium hydroxide, and lithium hydroxide, and sodium acetate, and basic amino acids such as guanidine.

With consideration for preserving properties of image-receiving paper (resistance to bleeding under the conditions of moisture and heat), a volatile base or a basic amino acid is preferred as the basic compound, and ammonia and guanidine are especially preferred.

The content of the basic compound in accordance with the invention is not particularly limited, but from the standpoint of obtaining the effect of the invention more effectively, it is preferred that this content be 0.01-0.3 wt. %, more preferably 0.02-0.1 wt. % in relation to the total amount of solids in all the ink-receiving layers (all the layers including the uppermost layer and the lower layer).

(Pseudoboehmite Alumina)

The ink-receiving layer (at least the uppermost layer; if necessary, the lower layer or other layers) includes pseudoboehmite alumina of at least one kind.

The pseudoboehmite alumina in accordance with the invention is an alumina hydrate represented by a structural formula Al₂O₃.nH₂O (1<n<3) where n is larger than 1 and less than 3.

Crystalline or amorphous pseudoboehmite alumina of irregular shape or of a spherical or plate-like shape can be used as the pseudoboehmite alumina. Pseudoboehmite alumina of one kind may be used, or two or more kinds of pseudoboehmite alumina may be used together.

Pseudoboehmite alumina of a plate-like or rod-like shape with an aspect ratio equal to or larger than 2 is particularly preferred.

A method of producing pseudoboehmite alumina is not particularly limited, and pseudoboehmite alumina can be produced, for example, by a well-known method such as hydrolysis of an aluminum alkoxide such as aluminum isopropoxide, neutralization of an aluminum salt with an alkali, and hydrolysis of an aluminate.

Commercial products of pseudoboehmite alumina are available, for example, from Nissan Chemical Industries, Ltd., Shokubai Kasei Kogyo Kabushiki Kaisha, Sasol Ltd., and Martinswerk Co.

The average particle size of primary particles of pseudoboehmite alumina in accordance with the invention is not particularly limited, but an average particle size equal to or less than 100 nm is preferred, 5-50 nm is more preferred, and 8-30 nm is especially preferred.

The average particle size of the primary particles was found by respectively determining the diameter of a circle having an area equal to the projected area of each of 100 particles present in a given area when the dispersed particles are observed under an electron microscope, and calculating the average diameter thereof.

An average particle size of secondary particles of pseudoboehmite alumina in accordance with the invention is not particularly limited, but an average particle size of 80-250 nm is preferred, and 120-200 nm is more preferred.

When the average particle size of secondary particles is within the aforementioned ranges, ink absorption ability and surface gloss are further improved.

The average particle size of secondary particles can be measured with a particle size distribution measurement device of a laser diffraction/scattering type or with a particle system distribution measurement device of a dynamic light scattering type by diluting a dispersion of alumina hydroxide to a concentration of solids equal to or less than 2%. The particle size of secondary particles is governed by dispersibility of alumina hydroxide, but can be adjusted to a certain degree by changing the amount of a deflocculating agent added or concentration of solids.

The pseudoboehmite alumina in accordance with the invention is preferably used in the form of a pseudoboehmite alumina dispersion.

Well-known dispersers such as a toothed-blade disperser, propeller impeller disperser, a high-pressure homogenizer, an ultrasound disperser, and a beads mill can be used for dispersing pseudoboehmite alumina.

When pseudoboehmite alumina is dispersed, a dispersion aid is preferably used.

Lactic acid, acetic acid, formic acid, nitric acid, hydrochloric acid, hydrobromic acid, and aluminum chloride can be used as the dispersion aid. Among them, inorganic acids are preferred because they have a high low-temperature viscosity.

The amount of the dispersion aid added is preferably 0.1-5 wt. % in relation to the pseudoboehmite alumina.

Where pseudoboehmite alumina dispersed in an acid is used, coating liquid properties are good and coating ability is also good even when boric acid or a borate is employed as a hardener (crosslinking agent). As a result, white paper glossiness and ink absorption ability are good.

A concentration of solids in the pseudoboehmite alumina dispersion used in accordance with the invention is preferably 10-35 wt. %, more preferably 20-30 wt. %, in terms of the amount of Al₂O₃.

It is preferable that the pseudoboehmite alumina in accordance with the invention has a cationic surface. As a result, a fixing effect of a colorant such as a dye used in the ink is increased and the amount of a dye mordant such as a cationic polymer that is added can be decreased or reduced to zero.

From the standpoint of obtaining the effect of the invention more effectively, it is preferred that the content of pseudoboehmite alumina in the ink-receiving layer in accordance with the invention be 40-90 wt. %, more preferably 50-80 wt. % in relation to the total amount of solids in the ink-receiving layer (for example, the uppermost layer) including the pseudoboehmite alumina.

(Inorganic Fine Particles)

The ink-receiving layer in accordance with the invention (at least the lower layer; if necessary, the uppermost layer or other layers) includes inorganic fine particles of at least one kind.

Examples of suitable inorganic fine particles include fine particle silica, colloidal silica, titanium dioxide, barium sulfate, calcium silicate, zeolites, kaolinite, halloysite, mica, talc, calcium carbonate, magnesium carbonate, calcium sulfate, boehmite alumina, and pseudoboehmite alumina.

Among them, pseudoboehmite alumina and fine particle silica are preferred as inorganic fine particles of the lower layer. The pseudoboehmite alumina referred to here is as described above, and the preferred ranges are also the same.

Because the aforementioned fine particle silica has an especially high specific surface area, ink can be absorbed and retained with high efficiency. Furthermore, because a refractive index of fine particle silica is low, the ink-receiving layer can be imparted with transparency and high color density and good coloring ability can be obtained, provided that dispersion is performed to an adequate fine particle diameter. Such a transparency of the ink-receiving layer is important not only for applications requiring transparency, such as OHP, but also from the standpoint of obtaining high color density and good coloring ability and gloss also in applications to a recording sheet such as a photoglossy paper.

Synthetic silica can be advantageously used as the fine particle silica.

The synthetic silica can be generally classified into a vapor-phase silica and wet silica, depending on the manufacturing method thereof.

The vapor-phase silica is also called dry silica and is generally produced by a flame hydrolysis method. More specifically, a production method is generally known in which silicon tetrachloride is combusted together with hydrogen and oxygen, but silanes such as methyltrichlorosilane and trichlorosilane can be also used individually or in a mixture with silicon tetrachloride instead of the silicon tetrachloride. Vapor-phase silica is marketed as AEROSIL by Japan Aerosil Co., Ltd. and QS type by Tokuyama KK and can be purchased therefrom.

An average primary particle size of the vapor-phase silica is preferably 5-50 nm. In order to obtain a higher gloss, a vapor-phase silica with an average primary particle size of 5-20 nm and a specific surface area of 90-400 m²/g (determined by a BET method) is preferred. The BET method as referred to in the present description is a method for measuring a surface area of a powder by a vapor-phase adsorption method. This method finds a total surface area of 1 g of a sample, that is, a specific surface area from an adsorption isotherm. Nitrogen gas is most often used as the adsorption gas, and the adsorbed amount of gas is most often measured from the pressure or volume variations of the adsorption gas. An equation suggested by Brunauer, Emmett, and Teller, which is called a BET equation, is the most famous equation representing an isotherm of multimolecular adsorption and it is widely used for determining the surface area. A surface area can be found by finding the adsorption amount based on the BET equation and multiplying by the area taken by one adsorbed molecule on the surface.

As described hereinabove, in vapor-phase silica, primary particles with a size from several nanometers to several tens of nanometers can be present in a state in which they form a network structure or are joined in chain-like two-dimensional aggregates. It is preferred that dispersing be performed to obtain an average particle size of aggregated particles of equal to or less than 500 nm, more preferably equal to or less than 300 nm. The lower limit for the particle size is about 50 nm. The average particle size of aggregated particles can be found from an photography obtained with a transmission electron microscope, but can be also measured in a simple manner as a number-median diameter by using a particle size distribution meter of a laser scattering type (for example, LA910 manufactured by Horiba, Ltd.).

Depending on the manufacturing method, wet silica can be further classified into precipitated silica, gel silica, and sol silica. The precipitated silica is manufactured by conducting a reaction of sodium silicate with sulfuric acid under alkali conditions. Silica particles produced and grown in the manufacturing process aggregate and precipitate. The product is obtained via subsequent filtration, washing with water, drying, grinding, and classification. Secondary particles of silica manufactured by this method become loose aggregated particles, and particles that are comparatively easy to grind can be obtained. Examples of commercially available precipitated silica include NIPSIL marketed by Toso Silica Co., Ltd. and TOKUSIL and FINESIL marketed by Tokuyama Co.

Gel silica is manufactured by conducting a reaction of sodium silicate with sulfuric acid under acidic conditions. In this case, small silica particles dissolve as the reaction progresses and re-precipitate between large primary particles, thereby bonding the primary particles together. As a result, distinct primary particles are eliminated and comparatively hard aggregated particles configured with internal cavities are formed. Examples of commercial products include MIZUCASIL marketed by Mizusawa Chemical Industries, Ltd. and SILOJET marketed by Grace Japan Co.).

Sol silica is also called colloidal silica. It is obtained by heating and maturing silica sol obtained by double decomposition of sodium silicate with an acid or via an ion-exchange resin layer. SNOWTEX is marketed by Nissan Chemical Industries Co., Ltd. as sol silica.

Precipitation silica or gel silica are preferred as the wet silica. An average particle size (average secondary particle size) of wet silica of these types is usually equal to or higher than 1 μm. Wet silica of these types is preferably ground to an average particle size of equal to or less than 500 nm, more preferably equal to or less than 300 nm. The lower limit for the particle size is about 50 nm. A particle diameter of the ground wet silica can be found, as described hereinabove, with a transmission electron microscope or a particle size distribution meter of a laser scattering type.

A process for grinding the wet silica preferably includes a primary dispersion step in which fine particle silica is added to a dispersion medium and mixed therewith (preliminary dispersing) and a secondary dispersion step in which silica contained in a coarse dispersion obtained in the primary dispersion step is ground. Preliminary dispersing in the primary dispersion step can be performed with the usual propeller stirring, a toothed blade disperser, turbine type stirring, homomixer-type stirring, and ultrasonic stirring. A wet dispersing method in which silica dispersed in a dispersion medium is mechanically ground can be advantageously used as a grinding method for wet silica. Examples of suitable wet dispersers include media mills such as a ball mill, a beads mill, and a sand grinder, pressure dispersers such as a high-pressure homogenizer and an ultrahigh-pressure homogenizer, an ultrasonic disperser, and a thin-film rotary-type disperser. A media mill such as a beads mill is especially preferred in accordance with the invention.

The wet silica preferably has an average particle size (average secondary particle size) of equal to or more than 5 μm. A dispersion with a higher density can be obtained by grinding silica with a comparatively large particle size. The upper limit of the average particle size of wet silica used in accordance with the invention is not particularly limited, but an average particle size of wet silica is usually equal to or less than 200 μm.

Precipitation silica is preferred as the wet silica. As described hereinabove, in precipitation silica, secondary particles are loose aggregated particles and, therefore, are advantageous for grinding.

In accordance with the invention, it is preferred that fine particle silica be cationized by the addition of a cationic compound. A cationic polymer, a water-soluble polyvalent metal compound, or a silane coupling agent can be used as the cationic compound. Among these cationic compounds, cationic polymers and water-soluble polyvalent metal compounds are preferred and cationic polymers are especially preferred.

A water-soluble cationic polymer having an acid adduct of a quaternary ammonium group, a phosphonium group, or a primary to tertiary amine is a cationic polymer that can be used in accordance with the invention. Examples of such polymers include polyethyleneimines, polydialkyldiallylamines, polyallylamines, alkylamine epichlorohydrin polycondensates, and cationic polymers described in JP-A Nos. 59-20696, 59-33176, 59-33177, 59-155088, 60-11389, 60-49990, 60-83882, 60-109894, 62-198493, 63-49478, 63-115780, 63-280681, 1-40371, 6-234268, 7-125411, and 10-193776, and WO 99/64248. A weight-average molecular weight of the cationic polymer used in accordance with the invention is preferably equal to or less than 100,000, more preferably equal to or less than 50,000, and even more preferably 2000 to about 30000.

An amount of the cationic polymer in accordance with the invention is preferably within a range of 1 -10 wt. % in relation to fine particle silica.

From the standpoint of obtaining the effect of the invention more effectively, content of inorganic fine particles in the ink-receiving layer in accordance with the invention is preferably 0.5-10 wt. %, more preferably 1-8 wt. % in relation to the total amount of solids in the ink-receiving layer (for example, the lower layer) including the inorganic fine particles.

(Binder)

The ink-receiving layer (at least the uppermost layer and lower layer and, if necessary, other layers) in accordance with the invention includes at least one binder.

A variety of well-known binders can be used as the binder, but it is preferred that a highly transparent hydrophilic binder that makes it possible to obtain an ink with higher permeation ability be used. When a hydrophilic binder is used, it is important that the hydrophilic binder does not swell and does not close pores during initial permeation of the ink. From this standpoint, a hydrophilic binder with low swelling ability at a temperature comparatively close to room temperature can be advantageously used. An especially preferred hydrophilic binder is a completely or partially saponified poly (vinyl alcohol) or cation-modified poly(vinyl alcohol).

A partially or completely saponified poly(vinyl alcohol) with a degree of saponification of equal to or more than 80% is especially preferred as the poly(vinyl alcohol). An average degree of polymerization thereof is preferably 200-5000.

Another example of a cation-modified polyvinyl alcohol is a poly(vinyl alcohol) having a primary to tertiary amino group or a quaternary ammonium group in the main chain or side chain of poly(vinyl alcohol), such as described, for example, in JP-A No. 61 -10483.

From the standpoint of obtaining the effect of the invention more effectively, it is preferred that the content of the binder in the ink-receiving layer in accordance with the invention be 5-30 wt. %, more preferably 7-20 wt. % in relation to the total amount of solids in the ink-receiving layer (for example, the uppermost layer or the lower layer) including the binder.

(Water-Soluble High-Boiling Point Solvent)

The ink-receiving layer (at least the uppermost layer; if necessary, the lower layer or other layers) in accordance with the invention includes at least one water-soluble high-boiling point solvent.

By including a water-soluble high-boiling point solvent, it is possible to inhibit bronzing. Furthermore, curing of a recording medium can be also inhibited.

“High-boiling point” as referred to herein means a boiling point equal to or higher than 120° C. under normal pressure.

The “water-soluble” as used herein means an ability to be dissolved to 1 wt. % or more in water at a normal temperature and under a normal pressure.

The boiling point of the water-soluble high-boiling solvent under a normal pressure is more preferably equal to or higher than 150° C., even more preferably equal to or higher than 180° C.

Examples of the water-soluble high-boiling point solvent include alcohols such as ethylene glycol, propylene glycol, diethylene glycol, triethylene glycol, glycerin, diethylene glycol monobutyl ether (DEGMBE), diethylene glycol monohexyl ether (DEGMHE), triethylene glycol monobutyl ether (TEGMBE), glycerin monomethyl ether, 1,2,3-butanetriol, 1,2,4-butanetriol, 1,2,4-pentanetriol, 1,2,6-hexanetriol, thiodiglycol, triethanolamine, and polyethylene glycol (weight-average molecular weight is equal to or less than 400).

From the standpoint of inhibiting bronzing, an ether high-boiling point solvent is preferred as the water-soluble high-boiling point solvent in accordance with the invention. Diethylene glycol monobutyl ether (DEGMBE), diethylene glycol monohexyl ether (DEGMHE), and triethylene glycol monobutyl ether (TEGMBE) are even more preferred.

The content of the water-soluble high-boiling point solvent in the coating liquid for forming the ink-receiving layer (for example, the below-described coating liquid B) is preferably 0.05-1 wt. %, especially preferably 0.1-0.6 wt. %.

(Cationic Polyurethane)

The ink-receiving layer (at least the lower layer; if necessary other layers) in accordance with the invention includes a cationic polyurethane and/or a zirconium salt.

The cationic polyurethane is a polyurethane having a cationic group.

Examples of cationic polyurethanes include polyurethanes synthesized, for example, by using various combinations of the below-described diol compounds and diisocyanate compounds and performing polyaddition.

Specific examples of diol compounds include ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3 -dimethyl- 1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycol (average molecular weight is equal to 200, 300, 400, 600, 1000, 1500, 4000), polypropylene glycol (average molecular weight is equal to 200, 400, 1000), polyesterpolyols, 4,4′-dihydroxydiphenyl-2,2-propane, and 4,4′-dihydroxyphenylsulfone.

Examples of diisocyanate compounds include methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3-dimethyl-4,4′-diphenylmethane diisocyanate, 3,3′-dimethylbiphenylene diisocyanate, 4,4′-biphenylene diisocyanate, dicyclohexylmethane diisocyanate, and methylenebis (4-cyclohexylisocyanate).

Examples of cationic groups contained in the cationic polyurethane in accordance with the invention include primary to tertiary amines and quaternary ammonium salts. A cationic polyurethane having a cationic group such as tertiary amine and a quaternary ammonium salt is preferred as the cationic polyurethane in accordance with the invention.

The cationic polyurethane can be obtained, for example, by using a composition obtained by introducing a cationic group into a diol such as described hereinabove when a polyurethane is synthesized. In the case of a quaternary ammonium salt, a polyurethane having a tertiary amine group may be quaternized with a quaternizing agent.

The diol compounds and diisocyanate compounds that can be used for synthesizing the polyurethane may be used by one compound of each kind, or two or more compounds of each kind may be combined and used at random ratios according to the desired object (for example, in order to adjust glass transition temperature (Tg) or solubility of the polymer and to improve mutual solubility with the binder and stability of dispersion).

Examples of commercial products of dispersions of the cationic polyurethanes include “SUPERFLEX 650”, “SUPERFLEX 650-5”, “F-8564D”, and “F-8570D” manufactured by Dai-ichi Kogyo Seiyaku Co., Ltd., and “NEOFIX IJ-150” manufactured by Nicca Chemical Co., Ltd.

The content of cationic groups in the cationic polyurethane is preferably 0.1-5 mmol/g, more preferably 0.2-3 mmol/g. Where the content of cationic groups is equal to or more than 0.1 mmol/g, the dispersion stability of the polymer can be further improved, and when the content of cationic groups is equal to or less than 5 mmol/g, mutual solubility with the binder can be further improved.

A glass transition temperature of the cationic polyurethane when it is used in an ink-receiving layer is not particularly limited, but is preferably within the following range. In order to prevent image bleeding with time over a long period after the image has been formed by inkjet recording and also to improve dimensional stability (resistance to curling), it is preferred that the glass transition temperature of the cationic polyurethane be less than 50° C. It is more preferred that the glass transition temperature of the cationic polyurethane be equal to or less than 30° C. and still more preferred that it be equal to or less than 15° C.

The lower limit of the glass transition temperature is not particularly limited, but from the standpoint of suitability for production during preparation of an aqueous dispersion, the glass transition temperature is about −30° C. in usual applications.

Usually, the weight-average molecular weight (Mw) of the cationic polyurethane is preferably 1000-200,000, more preferably 2000-50,000. When the molecular weight is equal to or higher than 1000, a more stable aqueous dispersion can be obtained. Furthermore, when the molecular weight is equal to or less than 200,000, solubility can be further increased, liquid viscosity can be further decreased, and an average particle size of aqueous dispersion can be further decreased (for example, controlled to a value equal to or less than 0.05 μm).

When the ink-receiving layer in accordance with the invention includes the cationic polyurethane, the content of the cationic polyurethane is preferably 0.1-30 wt. %, more preferably 0.3-20 wt. %, and most preferably 0.5-15 wt. % based on the total amount of solids in the ink-receiving layer (for example, the lower layer) including the cationic polyurethane. When this content is equal to or higher than 0.1 wt. %, the improvement of bleeding with time can be obtained more effectively. When the content is equal to or less than 30 wt. %, the fraction of fine particles and binder component increases and ink absorption ability can be further increased.

A method for preparing an aqueous dispersion of the cationic polyurethane will be described below.

An aqueous dispersion with an average particle size of equal to or less than 0.05 μm can be obtained by mixing the cationic polyurethane with an aqueous solvent, if necessary, also with additives to prepare a mixture, and finely powdering the mixture by using a disperser. A variety of well-known conventional dispersers such as a high-speed rotary disperser, a medium-stirring disperser (a ball mill, a sand mill, a beads mill, and the like), an ultrasonic disperser, a colloid mill disperser, and a high-pressure disperser can be used as the disperser for obtaining the aqueous dispersion. From the standpoint of efficiently dispersing the obtained ball-shaped fine particles, the medium-stirring disperser, colloid mill disperser, and a high-pressure disperser are preferred.

A detailed structure of the high-speed disperser (homogenizer) is described in U.S. Pat. No. 4,533,254 and JP-A No. 6-47264. Examples of suitable commercial products include a GAULIN HOMOGENIZER (A. P. V. Gaulin Inc.), MICROFLUIDIZER (Microfluidex Inc.), and ULTIMIZER (Sugino Machine KK). A high-pressure homogenizer equipped with a mechanism for atomization in an ultrahigh-pressure jet flow, such as described in U.S. Pat. No. 5,720,551 is especially effective for emulsifying and dispersing in accordance with the invention. DeBEE 2000 (BEE International Ltd.) is an example of an emulsification device using such an ultrahigh-pressure jet flow.

Water, organic solvents, or mixed solvents thereof can be used as the aqueous medium in the above-described dispersion process. Examples of organic solvents that can be used for such dispersion include alcohols such as methanol, ethanol, n-propanol, i-propanol, and methoxypropanol, ketones such as acetone and methyl ethyl ketone, and also tetrahydrofuran, acetonitrile, ethyl acetate, and toluene.

The cationic polyurethane itself can produce a naturally stable emulsified dispersion, but a small amount of a dispersant (surfactant) may be also used to accelerate the emulsification and dispersion and further improve stability. Examples of the surfactant that can be used for such a purpose include anionic surfactants such as fatty acid salts, alkylsulfonic acid esters, alkylbenzenesulfonates, alkylnaphthalenesulfonates, diakylsulfosuccinates, alkylphosphoric acid esters, napthalenesulfonic acid formalin condensate, and polyoxyethylene alkylsulfonic acid esters, and nonionic surfactants such as polyoxyethylene alkyl ethers, polyoxyethylene alkyl allyl ethers, polyoxyethylene fatty acid esters, sorbitan fatty acid esters, polyoxyethylene sorbitan fatty acid esters, polyoxyethylene alkylamines, glycerin fatty acid esters, and oxyethylene oxypropylene block copolymers. Furtehrmore, SURFYNOLS (Air Products & Chemical Co., Ltd.), which is acetylene-containing polyoxyethylene oxide surfactants, can be also advantageously used. Amineoxide amphoteric surfactants such as N,N-dimethyl-N-alkylamine oxide are also preferred. Compounds described as surfactants in JP-A No. 59-157,636 (pages 37-38) and Research Disclosure No. 308119 (1989) can be also used.

With the object of performing stabilization immediately after emulsification, a water-soluble polymer can be added together with the surfactant. The preferred examples of suitable water-soluble polymers include poly(vinyl alcohol), poly(vinyl pyrrolidone), polyethylene oxide, polyacrylic acid, polyacrylamides, and copolymers thereof. Natural water-soluble polymers such as polysaccharides, casein, and gelatin can be also advantageously used.

When the cationic polyurethane is dispersed in an aqueous dispersion medium by the above-described emulsification dispersion method, it is preferred that the particle size be controlled. Thus, in order to improve color purity and color density when an image is formed with an inkjet, it is preferred that an average particle size of the self-emulsifiable polymer in the aqueous dispersion be reduced. More specifically, the volume-average particle size of the cationic polyurethane in the ink-receiving layer in accordance with the invention is preferably equal to or less than 0.05 μm, more preferably equal to or less than 0.04 μm, and even more preferably equal to or less than 0.03 μm.

(Aqueous Dispersion of Cation-Modified Self-Emulsifiable Polymer)

The ink-receiving layer in accordance with the invention can also use a self-emulsifiable polymer subjected to cation modification (cation-modified self-emulsifiable polymer) other than the above-described cationic polyurethane in addition to the cationic polyurethane.

The “cation-modified self-emulsifiable polymer” means a polymer compound that can make a naturally stable emulsified dispersion in an aqueous dispersion medium, without using an emulsifier or a surfactant, or with addition of a very small amount thereof. Quantitatively, the “cation-modified self-emulsifiable polymer” represents a polymer substance that has a stable emulsification and dispersion ability at a concentration equal to or higher than 0.5 wt. % in an aqueous dispersion medium at a room temperature of 25° C., and this concentration is preferably equal to or higher than 1 wt. % and even more preferably equal to or higher than 3 wt. %.

More specifically, the “cation-modified self-emulsifiable polymer” is for example, a polyaddition- or polycondensation-type polymer compound having a cationic group such as a primary to tertiary amino group or a quaternary ammonium group.

Polymers obtained by polymerization of the below-described vinyl monomers are examples of vinyl polymerization-type polymers that are effective as the aforementioned polymers. Examples of the vinyl monomers include acrylic acid esters or methacrylic acid esters (the ester group is an optionally substituted alkyl group or aryl group, for example, a methyl group, an ethyl group, an n-propyl group, an isopropyl group, an n-butyl group, a sec-butyl group, a tert-butyl group, a hexyl group, a 2-ethylhexyl group, a tert-octyl group, a 2-chloroethyl group, a cyanoethyl group, a 2-acetoxyethyl group, a tetrahydrofurfuryl group, a 5-hydroxypentyl group, a cyclohexyl group, a benzyl group, a hydroxyethyl group, a 3-methoxybutyl group, a 2-(2-methoxyethoxy)ethyl group, a 2,2,2-trifluoroethyl group, a 1,2,2,2-tetrafluoroethyl group, a 1H,1H,2H,2H-perfluorodecyl group, a phenyl group, a 2,4,5-trimethylphenyl group, a 2,3,4,5-tetramethylphenyl group, a 2,4,5,6-tetramethylphenyl group, or a 4-chlorophenyl group);

vinyl esters, more specifically, optionally substituted aliphatic carboxylic acid vinyl esters (for example, vinyl acetate, vinyl propionate, vinyl butyrate, vinyl isobutyrate, vinyl caproate, and vinyl chloroacetate), optionally substituted aromatic carboxylic acid vinyl esters (for example, vinyl benzoate, vinyl 4-methyl benzoate, and vinyl salicylate);

acrylamides, more specifically, acrylamide, N-monosubstituted acrylamide, and N-disubstituted acrylamide (examples of the substituent include an alkyl group, an aryl group, and a silyl group, each of which is optionally substituted, for example, a methyl group, an n-propyl group, an isopropyl group, an n-butyl group, a tert-butyl group, a tert-octyl group, a cyclohexyl group, a benzyl group, a hydroxymethyl group, an alkoxymethyl group, a phenyl group, a 2,4,5-trimethylphenyl group, a 2,3,4,5-tetramethylphenyl group, a 2,4,5,6-tetramethylphenyl group, a 4-chlorophenyl group, and trimethylsilyl);

methacrylamides, more specifically, methacrylamide, N-monosubstituted methacrylamide, and N-disubstituted methacrylamide (examples of the substituent are an alkyl group, an aryl group, and a silyl group, each of which is optionally substituted, for example, a methyl group, an n-propyl group, an isopropyl group, an n-butyl group, a tert-butyl group, a tert-octyl group, a cyclohexyl group, a benzyl group, a hydroxymethyl group, an alkoxymethyl group, a phenyl group, a 2,4,5-trimethylphenyl group, a 2,3,4,5-tetramethylphenyl group, a 2,4,5,6-tetramethylphenyl group, a 4-chlorophenyl group, and trimethylsilyl);

olefins (for example, ethylene, propylene, 1-pentene, vinyl chloride, vinylidene chloride, isoprene, chloroprene, and butadiene);
styrenes (for example, styrene, methylstyrene, isopropylstyrene, methoxystyrene, acetoxystyrene, and chlorostyrene); and
vinyl ethers (for example, methyl vinyl ether, butyl vinyl ether, hexyl vinyl ether, and methoxyethyl vinyl ether).

Other examples of vinyl monomers include crotonic acid esters, itaconic acid esters, maleic acid diesters, fumaric acid diesters, methyl vinyl ketone, phenyl vinyl ketone, methoxyethyl vinyl ketone, N-vinyl oxazolidone, N-vinyl pyrrolidone, methylene malononitrile, diphenyl-2-acryloyl oxyethyl phosphate, diphenyl-2-methacryloyl oxyethyl phosphate, dibutyl-2-acryloyl oxyethyl phosphate, and dioctyl-2-methacryloyl oxyethyl phosphate.

Examples of the monomer having a cationic group include monomers having a tertiary amino group, such as dialkylaminoethyl methacrylates and dialkylaminoethyl acrylates.

Examples of the cation-modified self-emulsifiable polymer include polyesters having a cationic group.

Examples of polyesters having a cationic group include polyesters synthesized by a polycondensation reaction of a variety of combinations of the below-described diol compounds and dicarboxylic acid compounds.

Examples of the dicarboxylic acid compounds include oxalic acid, malonic acid, succinic acid, glutalic acid, dimethylmalonic acid, adipic acid, pimelic acid, α,α-dimethylsuccinic acid, acetonedicarboxylic acid, sebacic acid, 1,9-nonanedicarboxylic acid, fumaric acid, maleic acid, itaconic acid, citraconic acid, phthalic acid, isophthalic acid, terephthalic acid, 2-butylterephthalic acid, tetrachloroterephthalic acid, acetylenedicarboxylic acid, poly(ethylene terephthalate)dicarboxylic acid, 1,2-cyclohexanedicarboxylic acid, 1,4-cyclohexanedicarboxylic acid, co-poly(ethylene oxide)dicarboxylic acid, and p-xylylenedicarboxylic acid.

When a polycondensation reaction of the dicarboxylic acid compound and a diol compound is performed, the dicarboxylic acid compound for use in the reaction may be a dicarboxylic acid alkyl ester (for example, a dimethyl ester), or a dicarboxylate salt, or alternatively, a dicarboxylic acid anhydride, such as malic anhydride, succinic anhydride, or phthalic anhydride.

Compounds similar to the diols presented by way of examples with reference to the polyurethane can be also used as the aforementioned diol compounds.

The polyester having a cationic group is obtained by synthesis using a dicarboxylic acid compound having a cationic group such as a primary, secondary, tertiary, or quaternary ammonium salt.

The diol compound, dicarboxylic acids, and hydroxycarboxylic acid ester compound that are used for the synthesis of the polyester may be used by one compound of each kind, or two or more compounds of each kind may be combined and used at random ratios according to the desired object (for example, in order to adjust glass transition temperature (Tg) or solubility of the polymer and to improve mutual solubility with the dye and stability of dispersion).

(Zirconium Salt)

Examples of the zirconium salt used in accordance with the invention include zirconium acetate, zirconium oxyacetate (zirconyl acetate), zirconium chloride, zirconium oxychloride, zirconium hydroxychloride, zirconium nitrate, basic zirconium carbonate, zirconium hydroxide, zirconium lactate, zirconium ammonium carbonate, zirconium potassium carbonate, zirconium sulfate, and zirconium fluoride compounds.

Such compounds are marketed by Dai-ichi Kigenso Kagaku Kogyo Co., Ltd. as ZIRCOSOL ZA-20, ZIRCOSOL ZA-30, and ZIRCOSOL ZC-2. They are also marketed by Nippon Light Metal Co., Ltd.

The zirconium salts may be used individually or in combinations of two or more thereof.

When the ink-receiving layer in accordance with the invention includes a zirconium salt, the zirconium salt is preferably added at a proportion of equal to or higher than 1 wt. % and less than 30 wt. %, more preferably 2-25 wt. %, with respect to inorganic fine particles contained in the ink-receiving layer (for example, the lower layer) including the zirconium salt.

(Organic Compound having Sulfo Group)

From the standpoint of further improving ozone resistance, it is preferred that at least one layer (preferably, the uppermost layer) of the ink-receiving layer in accordance with the invention includes an organic compound having a sulfo group.

The organic compound having a sulfo group is not particularly limited, but a compound with small optical absorption in a visible range is preferred. Furthermore, it is preferred that the organic compound or a salt thereof (sulfonate) be soluble in water at 0.1 wt. % or higher.

Specific examples of the organic compound having a sulfo group include methanesulfonic acid, hydroxymethanesulfonic acid, ethanesulfonic acid, 1-propanesulfonic acid, 2-propanesulfonic acid, 1-butanesulfonic acid, 1-pentanesulfonic acid, 1-hexanesulfonic acid, 1-heptanesulfonic acid, 1-octanesulfonic acid, 1-nonanesulfonic acid, 1-decanesulfonic acid, vinylsulfonic acid, 2-methyl-2-propenesulfonic acid, aminomethanesulfonic acid, taurine, 3-amino-1-propanesulfonic acid, sulfoacetic acid, benzenesulfonic acid, 4-ethylbenzenesulfonic acid, 4-chlorobenzenesulfonic acid, p-toluenesulfonic acid, 2-naphthalenesulfonic acid, 1,5-naphthalenedisulfonic acid, trifluoromethanesulfonic acid, styrenesulfonic acid, and hydroxybenzenesulfonic acid. Among them, methanesulfonic acid, ethanesulfonic acid, benzenesulfonic acid, p-toluenesulfonic acid, 2-naphthalenesulfonic acid, and 1,5-naphthalenedisulfonic acid are especially preferred.

From the standpoint of increasing ozone resistance more effectively, it is preferred that the amount used of the organic compound having a sulfo group be 0.01 g/m² to 1.0 g/m², more preferably 0.02 g/m² to 0.8 g/m², and even more preferably 0.03 g/m² to 0.6 g/m².

From a similar standpoint, it is preferred that the content of the organic compound having a sulfo group be 0.004-0.45 wt. %, more preferably 0.008-0.36 wt. %, and even more preferably 0.012-0.27 wt. % in relation to the total amount of solids of all the ink-receiving layers.

Furthermore, it was found that when the organic compound having a sulfo group is introduced into the ink-receiving layer (that is, the ink-receiving layer using pseudoboehmite alumina as a porous pigment) in accordance with the invention, a significant effect can be obtained not only in increasing ozone resistance, but also in inhibiting bleeding due to moisture and heat and increasing print density.

From the standpoint of balance of inhibiting bleeding due to moisture and heat, increasing ozone resistance, and increasing print density, an organic compound having a naphthalene ring (also referred to hereinbelow as “organic compound having a sulfo group and a naphthalene ring”) is preferred among the organic compounds having a sulfo group.

Specific examples of the “organic compound having a sulfo group and a naphthalene ring” are 2-naphthalenesulfonic acid and 1,5-naphtalenedisulfonic acid.

The amount used of the “organic compound having a sulfo group and a naphthalene ring” is preferably 0.05 g/m² to 0.5 g/m², more preferably 0.1 g/m² to 0.2 g/m². When this amount is equal to or more than 0.05 g/m², the effect of inhibiting bleeding due to moisture and heat, increasing ozone resistance, and increasing print density can be achieved more effectively. When this amount is equal to or less than 0.5 g/m², print density can be further increased.

From a similar standpoint, it is preferred that the content of the “organic compound having a sulfo group and a naphthalene ring” be 0.02-0.25 wt. %, more preferably 0.04-0.10 wt. % in relation to the total amount of solids in all the ink-receiving layers.

(Water-Soluble Polyvalent Metal Compound)

A water-soluble polyvalent metal compound other than the above-described zirconium salt may be also contained in the ink-receiving layer in accordance with the invention.

The water-soluble polyvalent metal compound is preferably contained when the pseudoboehmite alumina and the inorganic fine particles are dispersed in water.

The water-soluble polyvalent metal compound as referred to herein is a compound of a metal with a valence of 2 or more that is dissolved to a level equal to or higher than 1 wt. % in water at 20° C.

Examples of the water-soluble polyvalent metal compound include water-soluble salts of one or more metals selected from aluminum, calcium, barium, manganese, copper, cobalt, nickel, iron, zinc, chromium, magnesium, tungsten, and molybdenum. Examples of specific compounds include aluminum sulfate, aluminum sulfite, aluminum thiosulfate, aluminum polychloride, aluminum nitrate nonahydrate, aluminum chloride hexahydrate, aluminum acetate, aluminum lactate, basic aluminum thioglycolate, calcium acetate, calcium chloride, calcium formate, calcium sulfate, calcium butyrate, barium acetate, barium sulfate, barium phosphate, barium oxalate, barium naphthoresorcine carboxylate, barium butyrate, manganese chloride, manganese acetate, manganese formate dihydrate, manganese ammonium sulfate hexahydrate, cupric chloride, ammonium copper (II) chloride dihydrate, copper sulfate, copper (II) butyrate, copper oxalate, copper phthalate, copper citrate, copper gluconate, copper naphthenate, cobalt chloride, cobalt thiocyanate, cobalt sulfate, cobalt (II) acetate, cobalt naphthenate, nickel sulfate hexahydrate, nickel chloride hexahydrate, nickel acetate tetrahydrate, nickel ammonium sulfate hexahydrate, nickel amidosulfate tetrahydrate, nickel sulfamate, nickel 2-ethylhexanoate, iron (II) bromide, iron (II) chloride, iron (III) chloride, iron (II) sulfate, iron (III) sulfate, iron (III) citrate, iron (III) lactate trihydrate, triammonium iron (III) trioxalate trihydrate, zinc bromide, zinc chloride, zinc nitrate hexahydrate, zinc sulfate, zinc acetate, zinc lactate, zirconium acetate, zirconium chloride, zirconium chloride oxide octahydrate, zirconium hydroxychloride, chromium acetate, chromium sulfate, magnesium acetate, magnesium oxalate, magnesium sulfate, magnesium chloride hexahydrate, magnesium citrate nonahydrate, sodium phosphotungstate, sodium tungsten citrate, 12-tungstophosphoric acid n-hydrate, 12-tungstosilicic acid 26-hydrate, molybdenum chloride, and 12-molybdophosphoric acid n-hydrate. These water-soluble polyvalent metal compounds may be used in combinations of two or more thereof.

Among these water-soluble polyvalent metal compounds, compounds of aluminum or a metal of group 4A of the periodic table of the elements (for example, titanium) are preferred. Water-soluble aluminum compounds are especially preferred. Examples of inorganic salts as water-soluble aluminum compounds include aluminum chloride or hydrates thereof, aluminum sulfate or hydrates thereof, and ammonium alum. A basic aluminum polyhydroxide compound, which is an inorganic aluminum-containing cation polymer, is also known and can be advantageously used.

The basic aluminum polyhydroxide compound as referred to herein is a basic water-soluble aluminum polyhydroxide having a main component represented by General Formula 1, 2, or 3 below and stably including a high-molecular polynuclear condensation ion such as [Al₆(OH)₁₅]³⁺, [Al₈(OH)₂₀]⁴⁺, [Al₁₃(OH)₃₄]⁵⁺, or [Al₂₁(OH)₆₀]³⁺.

[Al₂(OH)ₙCl₆₋ₙ]ₘ Formula 1.

[Al(OH)₃]ₙAlCl₃ Formula 2.

Alₙ(OH)ₘCl₍₃ₙ₋ₘ₎ 0<m<3n Formula 3.

Examples of these compounds include basic aluminum chloride (ALFINE 83) marketed by Taimei Chemicals Co., Ltd., poly(aluminum chloride) (PAC) by Taki Kagaku Co., Ltd., poly(aluminum hydroxide) (PAHO) as a water treatment agent by Asada Kagaku KK, and PURACHEM WT by Riken Green KK. Such compounds are also produced by other manufacturers with a similar object, and compounds of various grades are presently readily available.

(Hardener)

The ink-receiving layer (for example, the uppermost layer and/or lower layer) in accordance with the invention may contain a hardener (crosslinking agent) together with the binder.

Specific examples of the hardener include aldehyde compounds such as formaldehyde and glutalaldehyde, ketone compounds such as diacetyl and chloropentanedione, compounds including a reactive halogen such as bis(2-chloroethylurea)-2-hydroxy-4,6-dichloro-1,3,5-triazine and a compound described in U.S. Pat. No. 3,288,775, compounds having a reactive olefin such as divinylsulfone and a compound described in U.S. Pat. No. 3,635,718, N-methylol compounds such as described in U.S. Pat. No. 2,732,316, isocyanates such as described in U.S. Pat. No. 3,103,437, aziridine compounds such as described in U.S. Pat. Nos. 3,017,280 and 2,983,611, carbodiimide compounds such as described in U.S. Pat. No. 3,100,704, epoxy compounds such as described in U.S. Pat. No. 3,091,537, halogen carboxyaldehydes such as mucochloric acid, dioxane derivatives such as dihydroxydioxane, and inorganic hardeners such as chrome alum, zirconium sulfate, boric acid, and borates. These compounds may be used individually or in combinations of two or more thereof.

Among them, boric acid and borates are especially preferred.

When the ink-receiving layer in accordance with the invention includes a hardener, the hardener content is preferably 0.1-40 wt. %, more preferably 0.5-30 wt. % in relation to the binder constituting the ink-receiving layer.

(Other Components)

The ink-receiving layer in accordance with the invention may also include a silane coupling agent.

Examples of silane coupling agents are described in JP-A No. 2000-233572, and among them cationic coupling agents can be used. The amount of silane coupling agent added is preferably within a range of 0.1-10 wt. % in relation to the inorganic fine particles.

In accordance with the invention, various oil droplets can be introduced into the ink-receiving layer in order to improve the fragility of film. A hydrophobic high-boiling organic solvent (for example, fluid paraffin, dioctyl phthalate, tricresyl phosphate, and silicone oil) with a solubility in water at room temperature of equal to or less than 0.01 wt. % or polymer particles (for example, particles produced by polymerization of at least one polymerizable monomer such as styrene, butyl acrylate, divinylbenzene, butyl methacrylate, and hydroxyethyl methacrylate) can be used as such oil droplets. The oil droplets can be used preferably in an amount within a range of 10-50 wt. % in relation to the organic binder.

A variety of well-known additives such as a coloring dye, a coloring pigment, a UV absorber, an antioxidant, a pigment dispersant, an antifoaming agent, a leveling agent, a preservative, a fluorescent whitening agent, a viscosity stabilizer, and a pH regulating agent can be also added to the ink-receiving layer. A pH value of the coating liquid of the ink-receiving layer (A) in accordance with the invention is preferably within a range of 3.3-6.5, more preferably within a range of 3.5-5.5. ApH value of the coating liquid of the ink-receiving layer (B) in accordance with the invention is preferably within a range of 3.3-6.5, more preferably within a range of 4.0-6.0.

<Substrate>

The preferred substrate for use in accordance with the invention is a substrate that absorbs no water (referred to hereinbelow as “water-resistant substrate”), for example, plastic resin films such as a polyester resin such as polyethylene terephthalate, a diacetate resin, a triacetate resin, an acrylic resin, a polycarbonate resin, poly(vinyl chloride), a polyimide resin, cellophane, and celluloid, laminates of paper and a resin film, and paper coated with a polyolefin resin in which polyolefin resin layers are coated on both surfaces of base paper. The thickness of the water-resistant substrate is 50-300 μm, preferably 80-260 μm.

A substrate from paper coated with a polyolefin resin (referred to hereinbelow as “paper coated with a polyolefin resin”) that can be advantageously used in accordance with the invention will be described below in greater detail. A moisture content of the paper coated with a polyolefin resin for use in accordance with the invention is not particularly limited, but from the standpoint of curling, the moisture content is preferably within a range of 5.0-9.0%, more preferably 6.0-9.0%. The moisture content can be measured using any moisture measuring device. For example, an infrared moisture meter, a bone-dry weight method, a dielectric constant method, and a Karl-Fischer method can be used.

Base paper constituting the paper coated with a polyolefin resin is not particularly limited and generally employed paper can be used, but smooth base paper such as a paper used, for example, as a substrate for photography is more preferred. One pulp selected from natural pulp, regenerated pulp, and synthetic pulp, or a mixture of two or more pulps can be used as the pulp constituting the base paper. Additives such as a sizing agent, a paper durability enhancer, a filler, an antistatic agent, a fluorescent whitening agent, and a dye that are generally used in paper production can be compounded with the base paper.

Furthermore, the paper surface may be coated with a surface sizing agent, a surface durability enhancer, a fluorescent whitening agent, an antistatic agent, a dye, and an anchor agent.

A thickness of the base paper is not particularly limited, but paper with good surface smoothness that is produced by applying pressure using calendar, etc. and compressing during paper manufacturing or thereafter is preferred. A metric weight of the base paper is preferably 30-250 g/m².

Examples of polyolefin resins for coating the base paper include homopolymers such as low-density polyethylene, high-density polyethylene, polypropylene, polybutene, and polypentene, copolymers composed of two or more olefins such as ethylene-propylene copolymers, and mixtures thereof. Polyolefin resins of various densities and melt viscosity indexes (melt indexes) can be used individually or in mixtures.

A variety of additives can be appropriately combined and added to the resin of the paper coated with a polyolefin resin. Examples of such additives include a white pigment such as titanium oxide, zinc oxide, talc, or calcium carbonate, a fatty acid amide such as stearic acid amide or arachidic acid amide, a fatty acid metal salt such as zinc stearate, calcium stearate, aluminum stearate, or magnesium stearate, an antioxidant such as IRGANOX 1010 or IRGANOX 1076, blue pigments or dyes such as cobalt blue, ultramarine, cecilian blue, or phthalocyanine blue, magenta pigments or dyes such as cobalt violet, fast violet, or manganese violet, a fluorescent whitening agent, and an UV absorber.

The paper coated with a polyolefin resin is mainly manufactured by the so-called extrusion coating method in which a polyolefin resin is cast on a running base paper in a heated and molten state, and both sides of the base paper are covered with the resin. Before coating the resin on the base paper, the base paper is preferably subjected to an activation treatment such as a corona discharge treatment or a flame treatment. An appropriate thickness of the polyolefin resin layer is 5-50 μm.

It is preferred that an undercoating layer be provided on the side of the water-resistance substrate, used in accordance with the invention, where the ink-receiving layer is to be coated. This undercoating layer is coated on the surface of the water-resistant substrate and dried in advance, before the ink-receiving layer is coated. The undercoating layer mainly includes a water-soluble polymer or polymer latex that can form a film. Preferred water soluble polymers include gelatin, poly(vinyl alcohol), poly(vinyl pyrrolidone), and water-soluble cellulose, and especially preferred is gelatin. The coated amount of the water-soluble polymer is preferably 10-500 mg/m², more preferably 20-300 mg/m². Furthermore, it is preferred that the undercoating layer also includes a surfactant or a hardener. By providing the undercoating layer on the substrate it is possible to prevent hair cracking during coating of the ink-receiving layer with good effectiveness and obtain a uniform coating surface.

<<Method for Manufacturing Inkjet Recording Medium>>

A method for manufacturing the above-described inkjet recording medium in accordance with the invention is not particularly limited. For example, the following method can be employed for manufacturing the inkjet recording medium in accordance with the invention.

Thus a method for manufacturing the inkjet recording medium in accordance with the invention includes a step of forming an ink-receiving layer by coating at least a coating liquid A including inorganic fine particles, a binder, and a cationic polyurethane and/or a zirconium salt, and a coating liquid B including pseudoboehmite alumina, a binder, and a water-soluble high-boiling solvent on a substrate in the order of the coating liquid A and coating liquid B, as viewed from the substrate side, wherein at least one coating liquid for forming the ink-receiving layer includes a basic compound.

When the ink-receiving layer is formed, if necessary, one or more other coating liquids may be coated between the substrate and the coating liquid A, or between the coating liquid A and the coating liquid B, in addition to the coating liquid A and the coating liquid B.

The basic compound may be contained in at least one coating liquid (the coating liquid A, the coating liquid B, and/or other coating liquids that are used if necessary) for forming the ink-receiving layer.

From the standpoint of obtaining the effect of the invention more effectively, it is preferred that the basic compound be contained in the coating liquid A and /or the coating liquid B, more preferably in the coating liquid B.

Components of the above-described lower layer can be used as the inorganic fine particles, binder, and cationic polyurethane and/or zirconium salt and other optional components that are contained in the coating liquid A.

Components of the above-described uppermost layer can be used as the pseudoboehmite alumina, binder, water-soluble high-boiling solvent and other optional components that are contained in the coating liquid B.

Basic compounds and other components of the above-described ink-receiving layers can be used as the basic compound and other optional components that are contained in at least one coating liquid.

In the aforementioned manufacturing method, a method for coating the coating liquid A and the coating liquid B (and other components that are used if necessary) is not particularly limited, provided that coating is performed in the order of the coating liquid A and coating liquid B, as viewed from the substrate side.

For example, a successive coating method by which layers are successively and individually coated (for example, with a blade coater, an air knife coater, a roll coater, a bar coater, a gravure coater, or a reverse coater) or a simultaneous multilayer coating method (for example, with a slide bead coater or a slide curtain coater) may be used. Furthermore, for example, a “Wet-On-Wet Method” (referred to hereinbelow as “WOW method”) described in paragraphs 0016-0037 of JP-A No. 2005-14593 may be also used.

Among these methods, a multilayer simultaneous coating method is preferred.

(Preparation of Coating Liquid)

A method for preparing coating liquids (for example, the coating liquid A, coating liquid B, and other coating liquids that are used if necessary) for forming the ink-receiving layer in accordance with the invention is not particularly limited, and a known method by which the components contained in the coating liquids are mixed and stirred can be used.

From the standpoint of obtaining the effect of the invention more effectively, a method for preparing a coating liquid is preferred in which a dispersion of inorganic fine particles is first prepared (for example, a pseudoboehmite alumina dispersion or a vapor-phase silica dispersion), and then the prepared fine particle dispersion is mixed with other components.

In this case, it is preferred that the fine particle dispersion and other components are previously maintained at the same temperature and mixing is performed at the maintained temperature. The specific temperature of coating liquid is preferably 40-70° C., and is more preferably 45-60° C.

(Drying)

In accordance with the invention, a coating film (ink-receiving layer) formed by coating a coating liquid (for example, the coating liquid A and coating liquid B) for forming the ink-receiving layer can be dried by a known method.

The drying temperature is preferably within a range of 10-100° C., more preferably 20-80° C., the specific value depending on heat resistance of the substrate.

Furthermore, by performing heat treatment within a range providing no adverse effect on the substrate after coating and subsequent sufficient drying of the ink-receiving layer, it is possible to increase a pore volume of the ink-receiving layer. Therefore, ink absorption ability is improved and water resistance of the ink-receiving layer can be further increased. The temperature of heat treatment is preferably 30-80° C., more preferably 40-60° C., although the temperature depends on heat resistance of the substrate.

(Preferable Application Method for Organic Compound having a Sulfo Group)

When the ink-receiving layer in accordance with the invention includes the above-described “organic compound having a sulfo group”, an application method for the “organic compound having a sulfo group” onto the ink-receiving layer is not particularly limited. However, because the “organic compound having a sulfo group” is anionic in electric charge, from the standpoint of liquid stability, it is preferred that this compound be contained in a coating liquid other than the coating liquid A or coating liquid B and applied.

For example, from the standpoint of liquid stability, a method is preferred by which a basic solution C having a pH equal to or higher than 8.0 and including an organic compound having a sulfo group is prepared separately from the coating liquid A and coating liquid B, and the basic solution C is applied onto the coating liquid B by a simultaneous multilayer coating method or WOW method.

A pH value of the basic solution C can be appropriately adjusted to 8.0 or a higher value by using, for example, ammonia water, ammonium carbonate, sodium hydroxide, calcium hydroxide, and a compound including an amino group (ethylamine, ethanolamine, diethanolamine, polyallylamine, and the like). If necessary the basic solution C may include other components such as a crosslinking agent and a surfactant.

As a more specific method, it is preferable to include a step of forming an ink-receiving layer by forming a coating layer by coating at least the coating liquid A and the coating liquid B on the substrate in the order of the coating liquid A and the coating liquid B as viewed from the substrate side, and by applying the basic solution C onto the coating layer either (1) simultaneously with coating of the coating liquid B, or (2) during drying of the formed coating layer, but before the coating layer demonstrates decreasing drying (the method of (2) is a Wet On Wet method (WOW method)), wherein the basic compound is contained in at least one coating liquid (for example, coating liquid A, coating liquid B, or basic solution C) for forming the ink-receiving layer.

By forming the ink-receiving layer by this method, it is possible to inhibit aggregation or thickening of the pseudoboehmite alumina dispersion more effectively and form an inkjet recording medium with a very good gloss feel and high print density.

From the standpoint of further increasing the film strength by crosslinking and hardening, it is preferred that the coating liquid B and/or basic solution C in the above-described method include a crosslinking agent.

The expression “before the coating layer demonstrates decreasing drying” usually refers to an interval of several minutes from immediately after the coating liquid for the ink-receiving layer has been coated. Within this interval, a “constant-rate drying” phenomenon is demonstrated according to which the content of a solvent (dispersion medium) in the coated coating layer decreases proportionally to the time elapse. The time indicating the “constant-rate drying” is described, for example, in Kagaku Kogaku Benran (pages 707-712, published by Maruzen, Oct. 25, 1980).

Embodiments of the invention are set forth below. However, the invention is not limited to these embodiments.
<1> An inkjet recording medium, comprising:
   at least two ink-receiving layers on a substrate, wherein:
   at least one of the at least two ink-receiving layers comprises a basic compound; and
   among the at least two ink-receiving layers, an uppermost layer that is the farthest from the substrate comprises pseudoboehmite alumina, a binder, and a water-soluble high boiling point solvent, and a lower layer provided between the uppermost layer and the substrate comprises inorganic fine particles, a binder, and at least one of a cationic polyurethane or a zirconium salt.
<2> The inkjet recording medium according to <1>, wherein the basic compound is contained in the uppermost layer.
<3> The inkjet recording medium according to <1> or <2>, wherein the basic compound is an alcoholamine, a volatile base, an inorganic alkali agent, or a basic amino acid.
<4> The inkjet recording medium according to any one of <1> to <3>, wherein the content of the basic compound is 0.01 wt. %-0.3 wt. % in relation to the total amount of solids in all of the at least two ink-receiving layers.
<5> The inkjet recording medium according to any one of <1> to <4>, wherein the coating amount of pseudoboehmite alumina in the uppermost layer is 10 g/m²-30 g/m².
<6> The inkjet recording medium according to any one of <1> to <5>, wherein the content of pseudoboehmite alumina in the uppermost layer of the ink-receiving layer is 40 wt. %-90 wt. % in relation to the total amount of solids in all ink-receiving layers comprising pseudoboehmite alumina.
<7> The inkjet recording medium according to any one of <1> to <6>, wherein inorganic fine particles contained in the lower layer of the ink-receiving layer are fine particle silica, colloidal silica, titanium dioxide, barium sulfate, calcium silicate, zeolite, kaolinite, halloysite, mica, talc, calcium carbonate, magnesium carbonate, calcium sulfate, boehmite alumina, or pseudoboehmite alumina.
<8> The inkjet recording medium according to any one of<1> to <7>, wherein the coating amount of the inorganic fine particles in the lower layer is 9 g/m²-30 g/m².
<9> The inkjet recording medium according to any one of <1> to <8>, wherein the content of the inorganic fine particles in the lower layer of the ink-receiving layer is 0.5 wt. %-10 wt. % in relation to the total amount of solids in all ink-receiving layers comprising the inorganic fine particles.
<10> The inkjet recording medium according to any one of <1> to <9>, wherein each of the binder in the uppermost layer of the ink-receiving layer and the binder in the lower layer of the ink-receiving layer is a hydrophilic binder.
<11> The inkjet recording medium according to any one of <1> to <10>, wherein each of the binder in the uppermost layer of the ink-receiving layer and the binder in the lower layer of the ink-receiving layer is at least one hydrophilic binder selected from completely or partially saponified poly(vinyl alcohol) and cation-modified poly(vinyl alcohol).
<12> The inkjet recording medium according to any one of <l> to <11>, wherein the water-soluble high boiling point solvent in the uppermost layer of the ink-receiving layer is an alcohol.
<13> The inkjet recording medium according to any one of <1> to <12>, wherein the water-soluble high boiling point solvent in the uppermost layer of the ink-receiving layer is an ether alcohol.
<14> The inkjet recording medium according to any one of <1> to <13>, wherein the content of the water-soluble high boiling point solvent in a coating liquid for the uppermost layer of the ink-receiving layer is 0.05 wt. %-1 wt. %.
<15> The inkjet recording medium according to any one of <1> to <14>, wherein a cationic group of the cationic polyurethane is a primary, secondary, or tertiary amine group or a quaternary ammonium group.
<16> The inkjet recording medium according to any one of <1> to <15>, wherein the content of a cationic group of the cationic polyurethane is 0.1 mmol/g -5 mmol/g.
<17> The inkjet recording medium according to any one of <1> to <16>, wherein the content of the cationic polyurethane in the ink-receiving layer is 0.1 wt. %-30 wt. % in relation to the total amount of solids in the lower layer of the ink-receiving layer comprising the cationic polyurethane.
<18> The inkjet recording medium according to any one of <1> to <17>, wherein the content of the zirconium salt is equal to or more than 1 wt. % and less than 30 wt. % in relation to the inorganic fine particles in the lower layer of the ink-receiving layer comprising the zirconium salt.
<19> The inkjet recording medium according to any one of <1> to <18>, wherein at least one of the at least two ink-receiving layers comprises an organic compound having a sulfo group.
<20> The inkjet recording medium according to <19>, wherein the organic compound having a sulfo group has a naphthalene ring.
<21> A method of producing an inkjet recording medium comprising:

forming an ink-receiving layer by coating at least a coating liquid A comprising inorganic fine particles, a binder, and a cationic polyurethane and/or a zirconium salt and a coating liquid B comprising pseudoboehmite alumina, a binder, and a water-soluble high boiling point solvent on a substrate in the order of the coating liquid A and coating liquid B, as viewed from the substrate side, wherein

at least one coating liquid for forming the ink-receiving layer comprises a basic compound.

### EXAMPLES

The invention will be described below in greater detail with reference to examples therefor. The invention is not limited to the below-described examples, as long as the essence of the present invention is maintained. Furthermore, “parts” and “%” are based on a weight standard, unless stated otherwise.

### Example 1

<<Preparation of Inkjet Recording Medium>>

<Preparation of Upper Layer Coating Liquid>

A total of 42.0 kg of ion exchange water and 0.3 kg of 2.5 wt. % ammonia aqueous solution (aqueous solution of a basic compound) were added to a suction disperser CONTI-TDS (manufactured by Dalton Corp.), and then 18.1 kg of CATALOID AP-5 (pseudoboehmite alumina, primary particle size 8 nm, manufactured by Shokubai Kasei Kogyo Kabushiki Kaisha) was added by small portions under stirring at a maximum rotation speed, and a white coarse dispersion of pseudoboehmite was obtained. The dispersion time in this case was 35 minutes.

The white coarse dispersion of pseudoboehmite was finely dispersed with a high-pressure disperser (ULTIMIZER-HJP25005, manufactured by Sugino Machine KK), and a transparent pseudoboehmite dispersion with a concentration of solids of 30 wt. % was obtained. The pressure in this process was 100 MPa, and the discharge rate was 600 g/min.

A particle size of the transparent pseudoboehmite dispersion was 0.050 μm.

585 g of the obtained transparent pseudoboehmite dispersion, 186.5 g of ion exchange water, 10.8 g of diethylene glycol monobutyl ether (BUTYCENOL 20P, water-soluble high-boiling solvent, manufactured by Kyowa Hakko Chemicals Co., Ltd.), 240.7 g of poly(vinyl alcohol) with a degree of saponification of 88% and a degree of polymerization of 3500 (PVA235, manufactured by Kuraray Co., Ltd.), and 1.0 g of a 10% surfactant aqueous solution (SWANOL AM2150, manufactured by Nikko Chemicals Co., Ltd.) were each kept at 50° C. and then mixed to obtain a pseudoboehmite coating liquid (upper layer coating liquid; coating liquid B).

<Preparation of Lower Layer Coating Liquid)

42.3 kg of ion exchange water was added to a suction disperser CONTI-TDS (manufactured by Dalton Corp.), and 20.2 kg of CATALOID AP-5 (pseudoboehmite alumina, primary particle size 8 nm, manufactured by Shokubai Kasei Kogyo Kabushiki Kaisha) was added by small portions under stirring at a maximum rotation speed to obtain a white coarse dispersion of pseudoboehmite. The dispersion time in this case was 35 minutes.

The white coarse dispersion of pseudoboehmite was finely dispersed with a high-pressure disperser (ULTIMIZER-HJP25005, manufactured by Sugino Machine KK), and a transparent pseudoboehmite dispersion with a concentration of solids of 30 wt. % was obtained. The pressure in this process was 100 MPa, and the discharge rate was 600 g/min.

A particle size of the transparent pseudoboehmite dispersion was 0.050 μm.

585 g of the obtained transparent pseudoboehmite dispersion, 183.8 g of ion exchange water, 4.5 g of an aqueous solution of zirconium acetate (ZIRCOSOL ZA-30, manufactured by Dai-ichi Kigenso Kagaku Kogyo Co., Ltd.), 9 g of cationic polyurethane dispersion (SUPERFLEX 650-5, manufactured by Dai-ichi Kogyo Seiyaku Co., Ltd.), 240.7 g of poly(vinyl alcohol) with a degree of saponification of 88% and a degree of polymerization of 3500 (PVA235, manufactured by Kuraray Co., Ltd.), and 1.0 g of a 10% surfactant aqueous solution (SWANOLAM2150, manufactured by Nikko Chemicals Co., Ltd.) were each kept at 50° C. and then mixed to obtain a pseudoboehmite coating liquid (lower layer coating liquid; coating liquid A).

<Fabrication of Substrate>

A 1:1 mixture of leaf bleached Kraft pulp (LBKP) and needle bleached sulfite pulp (NBSP) was crushed to obtain 300 ml with a freeness according to a Canadian standard and prepare a pulp slurry. An alkyl ketene dimmer was added as a sizing agent at 0.5 wt. % in relation to the pulp, polyacrylamide was added as a reinforcing agent at 1.0 wt. % in relation to the pulp, cationized starch was added at 2.0 wt. % in relation to the pulp, and a polyamidoepichlorohydrin resin was added at 0.5 wt. % in relation to the pulp, followed by diluting with water. As a result, a 1% slurry was obtained. The slurry was processed at a long-mesh papermaking machine to obtain a metric weight of 170 g/m², dried to adjust the moisture level, thereby producing a base paper for a paper coated with a polyolefin resin.

A polyethylene resin composition prepared by homogeneously dispersing 10 wt. % anatase-type titanium oxide in a resin having a density of 0.918 g/cm³ and containing 100 wt. % low-density polyethylene was melted at a temperature of 320° C., the melt was extrusion coated at 200 m/min on one surface of the produced base paper so as to obtain a thickness of 35 μm, and then treated with a finely finished cooling roll (this surface will be referred to hereinbelow as “front surface”).

A blended resin composition including 70 parts by weight of a high-density polyethylene resin with a density of 0.962 g/cm³ and 30 parts by weight of a low-density polyethylene resin with a density of 0.918 g/cm³ was similarly melted at a temperature of 320° C., the melt was extrusion coated on the other surface of the produced base paper so as to obtain a thickness of 30 μm, and then treated with a coarsely finished cooling roll (this surface will be referred to hereinbelow as “rear surface”).

Paper coated with a polyolefin resin in which both surfaces of a base paper were coated with the resin was thus obtained.

The front surface of the paper coated with a polyolefin resin was subjected to a high-frequency corona discharge processing, and then an undercoating layer of the below-described composition was coated and dried to obtain a metric weight of gelatin of 50 mg/m², thereby producing a substrate.

Composition of Undercoating Layer

| | | |
|---|---|---|
| Lime-treated gelatin | 100 | parts |
| 2-ethylhexyl sulfosuccinate | 2 | parts |
| Chrome alum | 10 | parts |

<Formation of Ink-receiving Layer>

The obtained upper layer coating liquid and lower layer coating liquid were kept at 50° C., and 188 g of a 7.5% aqueous solution of boric acid kept at the same temperature was in-line added to the upper layer coating liquid, and thereafter the upper layer coating liquid and lower layer coating liquid were simultaneously multilayer coated on the undercoating layer of the substrate with a slide bead coating device in the order of the lower layer coating liquid and upper layer coating liquid from the side of the undercoating layer. The coating layers obtained by the simultaneous multilayer coating were set and dried for 2 min to obtain a film surface temperature of 20° C., and then drying was performed for 10 min at a temperature of 80° C. to obtain an ink-receiving layer. In this case, the coating amount of pseudoboehmite alumina in the upper layer coating liquid and the coating amount of inorganic fine particles (pseudoboehmite alumina) in the lower layer coating liquid was 19 g/m² each.

The above-described operations produced an inkjet recording medium having the ink-receiving layer on the substrate.

<<Evaluation>>

The following evaluation was performed with respect to the obtained inkjet recording medium. The evaluation results are shown in Table 1 below.

<Bronzing>

A cyan 100% solid portion was printed with a commercial inkjet printer (PM-A820, manufactured by Seiko Epson Co., Ltd.), the occurrence of bronzing was verified, and bronzing was evaluated according to the following evaluation criteria.

### Evaluation Criteria

A: A ghost image caused by fluorescent light maintained whiteness and showed no reddening at all
B: A ghost image caused by fluorescent light showed slight reddening
C: A ghost image caused by fluorescent light showed reddening
D: A ghost image caused by fluorescent light showed total reddening

<Print Density>

Yellow, magenta, cyan, and black solid printing was performed using inkjet printer PM-A820 manufactured by Seiko Epson Co., Ltd.

The image density of solid printed portions of cyan (C), black (K), yellow (Y), and magenta (M) was measured using GRETAG SPECTROLINO SPM-50 without a filter under conditions of a view angle of 2° and a light source D50.

Similar measurements were also performed by replacing the aforementioned inkjet printer with an inkjet printer PIXUS MP950 manufactured by Canon Inc. and inkjet printer C5175 manufactured by Hewlett Packard Corp.

<Bleeding Due to Moisture and Heat>

Fine lines of red, green, blue, and composite black were printed with a commercial inkjet printer (PIXUS 850i, manufactured by Canon Inc.), a sample maintained in an environment with 30° C. and 80% was visually observed after 1 week, and bleeding caused by moisture and heat was evaluated according to the below-described evaluation criteria.

Similar measurements were also performed by replacing the aforementioned inkjet printer with an inkjet printer PM-970C manufactured by Seiko Epson Co., Ltd. and inkjet printer PM-A820 manufactured by Seiko Epson Co., Ltd.

### Evaluation Criteria

A: No bleeding
B: Slight bleeding is observed
C: Bleeding is observed
D: Significant bleeding

<Ozone Resistance>

Black printing at a maximum density was performed with a commercial inkjet printer (C5175 manufactured by Hewlett Packard Corp.) and the print was held for 48 hours in an environment with 23° C. and 50% and an ozone concentration of 1 ppm. A black residual ratio was calculated from the print density before and after holding.

Ozone resistance was evaluated according to the following criteria on the basis of the obtained residual ratio.

### Evaluation Criteria

A: Residual ratio is equal to or more than 80%
B: Residual ratio is 60%-80%
C: Residual ratio is 40%-60%
D: Residual ratio is less than 40%

### Example 2

An inkj et recording medium was fabricated in the same manner as in Example 1, except that the aqueous solution of zirconium acetate (ZIRCOSOL ZA-30, manufactured by Dai-ichi Kigenso Kagaku Kogyo Co., Ltd.) was removed from the lower layer coating liquid. The evaluation was performed in the same manner as in Example 1. The evaluation results are shown in Table 1 below.

### Example 3

An inkjet recording medium was fabricated in the same manner as in Example 1, except that the cationic polyurethane dispersion (SUPERFLEX 650-5, manufactured by Dai-ichi Kogyo Seiyaku Co., Ltd.), was removed from the lower layer coating liquid. The evaluation was performed in the same manner as in Example 1. The evaluation results are shown in Table 1 below.

### Example 4

An inkjet recording medium was fabricated in the same manner as in Example 1, except that ammonia, which was a basic compound contained in the upper layer coating liquid, was replaced with the same amount of sodium acetate. The evaluation was performed in the same manner as in Example 1. The evaluation results are shown in Table 1 below.

### Example 5

An inkjet recording medium was fabricated in the same manner as in Example 1, except that the lower layer coating liquid was replaced with the below-described lower layer coating liquid 2 and the coating amount of pseudoboehmite alumina of the upper layer coating liquid and the coating amount of inorganic fine particles (vapor-phase silica) of the lower layer coating liquid were the coating amounts shown in Table 1. The evaluation was performed in the same manner as in Example 1. The evaluation results are shown in Table 1 below.

<Preparation of Lower Layer Coating Liquid 2>

(Preparation of Vapor-Phase Silica)

A dimethyldiallyl ammonium chloride homopolymer was added to modified ethanol and water as a dispersion medium, and then vapor-phase silica was added, preliminary dispersing was performed, thereby preparing a coarse dispersion. The coarse dispersion was treated twice with a high-pressure homogenizer, and thereby a vapor-phase silica dispersion (composition is described below) with a silica concentration of 20 wt. % was prepared. An average particle diameter of vapor-phase silica was 100 nm.

Composition of Vapor-Phase Silica Dispersion

| | | |
|---|---|---|
| Water | 430 | parts |
| Modified ethanol | 22 | parts |
| Cationic polymer (dimethyldiallyl ammonium chloride | 3 | parts |
| homopolymer, manufactured by Dai-ichi Kogyo | | |
| Seiyaku Co., Ltd., SHALLOL DC902P, average | | |
| molecular weight 9000) | | |
| Vapor-phase silica (average primary particle size 7 nm, | 100 | parts |
| specific surface area determined by a | | |
| BET method 300 m²/g) | | |

(Preparation of Lower Layer Coating Liquid 2)

The following components were mixed and stirred to prepare the lower layer coating liquid 2.

Composition of Lower Layer Coating Liquid

| | | |
|---|---|---|
| Vapor-phase silica dispersion obtained as described | 100 | parts |
| hereinabove (as a solid fraction of vapor-phase silica) | | |
| Boric acid | 3 | parts |
| Poly(vinyl alcohol) (degree of saponification 88%, | 22 | parts. |
| average degree of polymerization 3500) | | |
| Zirconyl acetate (ZIRCOSOL ZA-30, manufactured by | 3 | parts |
| Dai-ichi Kigenso Kagaku Kogyo Co., Ltd.) | | |
| Surfactant (betaine-type, SWANOL AM-2150, | 0.1 | part. |
| manufactured by Japan Surfactant Co., Ltd.) | | |

### Example 6

An inkjet recording medium was fabricated in the same manner as in Example 1, except that the water-soluble high-boiling solvent (diethylene glycol monobutyl ether) contained in the upper layer coating liquid was replaced with the same amount of triethylene glycol monobutyl ether, which is a water-soluble high-boiling solvent. The evaluation was performed in the same manner as in Example 1. The evaluation results are shown in Table 1 below.

### Example 7

An inkjet recording medium was fabricated in the same manner as in Example 1, except that water-soluble high-boiling solvent (diethylene glycol monobutyl ether) contained in the upper layer coating liquid was replaced with the same amount of triethylene glycol monohexyl ether, which is a water-soluble high-boiling solvent. The evaluation was performed in the same manner as in Example 1. The evaluation results are shown in Table 1 below.

### Example 8

An upper layer coating liquid and a lower layer coating liquid were prepared in the same manner as in Example 1.

<Formation of Ink-receiving Layer>

The obtained upper layer coating liquid and lower layer coating liquid were each kept at 50° C., and 188 g of a 7.5% aqueous solution of boric acid kept at the same temperature was in-line added to the upper layer coating liquid, and thereafter the upper layer coating liquid and lower layer coating liquid were simultaneously multilayer coated on the undercoating layer of the substrate with a slide bead coating device in the order of the lower layer coating liquid and the upper layer coating liquid from the side of the undercoating layer. The coating layers obtained by the simultaneous multilayer coating were set and dried for 2 minutes to obtain a film surface temperature of 20° C., and then drying was performed at a temperature of 80° C. to obtain a concentration of solids in the coating layer of 40%. The coating layer demonstrated constant-rate drying within this period.

Immediately thereafter, the coating layer dried to the concentration of solids of 40% was immersed for 3 seconds in the basic solution C of the below-described composition, and the basic solution C was applied at 13 g/m² to the coating layer. The coating layer to which the basic solution C has been applied was then dried for 10 minutes at 80° C. to obtain an ink-receiving layer.

The coating amount of pseudoboehmite alumina of the upper layer coating liquid and the coating amount of inorganic fine particles (pseudoboehmite alumina) of the lower layer coating liquid in the simultaneous multilayer coating process were 19 g/m² each.

An inkjet recording medium having an ink-receiving layer on a substrate was thus obtained.

The obtained inkjet recording medium was evaluated in the same manner as in Example 1. The evaluation results are shown in Table 2 below.

Composition of Basic Solution C

| | | |
|---|---|---|
| Boric acid | 0.6 | part |
| Ammonium carbonate | 5 | parts |
| Polyoxyethylene lauryl ether (surfactant) | 0.6 | part |
| 1.5-Naphthalenedisulfonic acid | 0.75 | part |
| 2.5% Ammonia water | 6 | parts |
| Ion exchange waster | 85.8 | parts. |

### Example 9

An inkjet recording medium was fabricated in the same manner as in Example 8, except that the amount of 1,5-naphthalenedisulfonic acid of Example 8 was changed from 0.75 parts to 1.50 parts. The evaluation was performed in the same manner as in Example 1. The evaluation results are shown in Table 2 below.

### Examples 10-11

Inkjet recording media were fabricated in the same manner as in Example 1, except that the coating amount of pseudoboehmite alumina of the upper layer coating liquid and the coating amount of inorganic fine particles (pseudoboehmite alumina) of the lower layer coating liquid during formation of the ink-receiving layer in the process of Example 1 were changed as shown in Table 2 below. The evaluation was performed in the same manner as in Example 1.

The evaluation results are shown in Table 2 below.

### Comparative Example 1

An inkjet recording medium was fabricated in the same manner as in Example 1, except that diethylene glycol monobutyl ether was removed from the upper layer coating liquid. The evaluation was performed in the same manner as in Example 1. The evaluation results are shown in Table 3 below.

### Comparative Example 2

An inkjet recording medium was fabricated in the same manner as in Example 1, except that 2.5 wt. % ammonia aqueous solution was removed from the upper layer coating liquid. The evaluation was performed in the same manner as in Example 1. The evaluation results are shown in Table 3 below.

### Comparative Example 3

An inkjet recording medium was fabricated in the same manner as in Example 1, except that the aqueous solution of zirconium acetate (ZIRCOSOL ZA-30, manufactured by Dai-ichi Kigenso Kagaku Kogyo Co., Ltd.) and cationic polyurethane dispersion (SUPERFLEX 650-5, manufactured by Dai-ichi Kogyo Seiyaku Co., Ltd.) were removed from the lower layer coating liquid. The evaluation was performed in the same manner as in Example 1. The evaluation results are shown in Table 3 below.

### Comparative Example 4

An inkjet recording medium was fabricated in the same manner as in Example 1, except that diethylene glycol monobutyl ether and 2.5 wt. % ammonia aqueous solution were removed from the upper layer coating liquid and the lower layer coating liquid was replaced with the lower layer coating liquid 2 of Example 5. The evaluation was performed in the same manner as in Example 1. The evaluation results are shown in Table 3 below.

### Comparative Example 5

An inkjet recording medium was fabricated in the same manner as in Example 1, except that the lower layer coating liquid was not used and only the upper layer coating liquid was coated as a single layer at a coating amount of pseudoboehmite alumina of 38 g/m2 in the formation of the ink-receiving layer by the process of Example 1. The evaluation was performed in the same manner as in Example 1.

The evaluation results are shown in Table 3 below.

### Comparative Example 6

An inkjet recording medium was fabricated in the same manner as in Example 1, except that the upper layer coating liquid was not used and only the lower layer coating liquid was coated as a single layer at a coating amount of inorganic fine particles (pseudoboehmite alumina) of 3 8 g/m² in the formation of the ink-receiving layer by the process of Example 1. The evaluation was performed in the same manner as in Example 1.

The evaluation results are shown in Table 3 below.

### Comparative Example 7

An inkjet recording medium was fabricated in the same manner as in Comparative Example 5, except that SUPERFLEX 650-5 was added as a component of the upper layer coating liquid to obtain a coating amount thereof of 0.25 g/m² in the process of Comparative Example 5. The evaluation was performed in the same manner as in Example 1.

The evaluation results are shown in Table 3 below.

### Comparative Example 8

An inkjet recording medium was fabricated in the same manner as in Comparative Example 6, except that DEGMBE was added as a component of the lower layer coating liquid to obtain a coating amount thereof of 1.2 g/m² in the process of Comparative Example 6. The evaluation was performed in the same manner as in Example 1.

The evaluation results are shown in Table 3 below.

TABLE 1

| | | Example 1 | Example 2 | Example 3 | Example 4 |
|---|---|---|---|---|---|
| Upper layer | Inorganic fine particles | Pseudoboehmite | Pseudoboehmite | Pseudoboehmite | Pseudoboehmite |
| | High-boiling solvent | DEGMBE | DEGMBE | DEGMBE | DEGMBE |
| | Fine particles of | None | None | None | None |
| | cationic polyurethane | | | | |
| | Basic compound | Ammonia | Ammonia | Ammonia | Sodium acetate |
| | Organic compound | None | None | None | None |
| | having sulfo group | | | | |
| | Coating amount of | 19 | 19 | 19 | 19 |
| | pseudoboehmite (g/m²) | | | | |
| Lower layer | Inorganic fine particles | Pseudoboehmite | Pseudoboehmite | Pseudoboehmite | Pseudoboehmite |
| | High-boiling solvent | None | None | None | None |
| | Fine particles of | SUPERFLEX | SUPERFLEX | None | SUPERFLEX |
| | cationic polyurethane | 650-5 | 650-5 | | 650-5 |
| | Zirconium salt | ZIRCOSOL | None | ZIRCOSOL | ZIRCOSOL |
| | | ZA-30 | | ZA-30 | ZA-30 |
| | Coating amount of | 19 | 19 | 19 | 19 |
| | inorganic fine particles | | | | |
| | (g/m²) | | | | |
| Bronzing | | B | B | B | B |
| Print | Y (A820) | 1.65 | 1.65 | 1.62 | 1.62 |
| density | M (A820) | 1.05 | 1.05 | 1.05 | 1.04 |
| | C (A820) | 0.49 | 0.5 | 0.48 | 0.49 |
| | K (A820) | 2.95 | 2.96 | 2.96 | 2.96 |
| | K (C5175) | 2.70 | 2.70 | 2.70 | 2.70 |
| | K (MP950) | 2.75 | 2.76 | 2.76 | 2.76 |
| Bleeding | PM970C | A | B | C | B |
| due to heat | PIXUS 850i | A | A | B | B |
| and | A820 | C | C | C | C |
| moisture | | | | | |
| Ozone | K (C5175) | C | C | C | C |
| resistance | | | | | |

| | | Example 5 | Example 6 | Example 7 |
|---|---|---|---|---|
| Upper layer | Inorganic fine particles | Pseudoboehmite | Pseudoboehmite | Pseudoboehmite |
| | High-boiling solvent | DEGMBE | TEGMBE | DEGMHE |
| | Fine particles of | None | None | None |
| | cationic polyurethane | | | |
| | Basic compound | Ammonia | Ammonia | Ammonia |
| | Organic compound | None | None | None |
| | having sulfo group | | | |
| | Coating amount of | 19 | 19 | 19 |
| | pseudoboehmite (g/m²) | | | |
| Lower layer | Inorganic fine particles | Silica | Pseudoboehmite | Pseudoboehmite |
| | High-boiling solvent | None | None | None |
| | Fine particles of | None | SUPERFLEX | SUPERFLEX |
| | cationic polyurethane | | 650-5 | 650-5 |
| | Zirconium salt | ZIRCOSOL | ZIRCOSOL | ZIRCOSOL |
| | | ZA-30 | ZA-30 | ZA-30 |
| | Coating amount of | 9 | 19 | 19 |
| | inorganic fine particles | | | |
| | (g/m²) | | | |
| Bronzing | | B | B | B |
| Print | Y (A820) | 1.63 | 1.65 | 1.65 |
| density | M (A820) | 1.03 | 1.05 | 1.05 |
| | C (A820) | 0.48 | 0.49 | 0.49 |
| | K (A820) | 2.95 | 2.95 | 2.95 |
| | K (C5175) | 2.70 | 2.70 | 2.70 |
| | K (MP950) | 2.76 | 2.76 | 2.76 |
| Bleeding | PM970C | C | A | A |
| due to heat | PIXUS 850i | B | A | A |
| and | A820 | C | C | C |
| moisture | | | | |
| Ozone | K (C5175) | C | C | C |
| resistance | | | | |

TABLE 2

| | | Example 8 | Example 9 | Example 10 | Example 11 |
|---|---|---|---|---|---|
| Upper layer | Inorganic fine particles | Pseudoboehmite | Pseudoboehmite | Pseudoboehmite | Pseudoboehmite |
| | High-boiling solvent | DEGMBE | DEGMBE | DEGMBE | DEGMBE |
| | Fine particles of | None | None | None | None |
| | cationic polyurethane | | | | |
| | Basic compound | Ammonia | Ammonia | Ammonia | Ammonia |
| | Organic compound | Naphthalenedisulfonic | Naphthalenedisulfonic | None | None |
| | having sulfo group | acid (0.1 g/m²) | acid (0.2 g/m²) | | |
| | Coating amount of | 19 | 19 | 9.5 | 4.6 |
| | pseudoboehmite (g/m²) | | | | |
| Lower layer | Inorganic fine particles | Pseudoboehmite | Pseudoboehmite | Pseudoboehmite | Pseudoboehmite |
| | High-boiling solvent | None | None | None | None |
| | Fine particles of | SUPERFLEX | SUPERFLEX | SUPERFLEX | SUPERFLEX |
| | cationic polyurethane | 650-5 | 650-5 | 650-5 | 650-5 |
| | Zirconium salt | ZIRCOSOL | ZIRCOSOL | ZIRCOSOL | ZIRCOSOL |
| | | ZA-30 | ZA-30 | ZA-30 | ZA-30 |
| | Coating amount of | 19 | 19 | 28.5 | 33.4 |
| | inorganic fine particles | | | | |
| | (g/m²) | | | | |
| Bronzing | | B | B | C | C |
| Print | Y (A820) | 1.64 | 1.66 | 1.60 | 1.60 |
| density | M (A820) | 1.05 | 1.06 | 1.06 | 1.00 |
| | C (A820) | 0.50 | 0.51 | 0.50 | 0.45 |
| | K (A820) | 2.95 | 2.95 | 2.97 | 2.97 |
| | K (C5175) | 2.75 | 2.85 | 2.70 | 2.70 |
| | K (MP950) | 2.81 | 2.90 | 2.75 | 2.75 |
| Bleeding | PM970C | A | A | A | A |
| due to heat | PIXUS 850i | A | A | A | A |
| and | A820 | B | A | B | C |
| moisture | | | | | |
| Ozone | K (C5175) | B | A | C | C |
| resistance | | | | | |

TABLE 3

| | | Comparative | Comparative | Comparative | Comparative |
|---|---|---|---|---|---|
| | | Example 1 | Example 2 | Example 3 | Example 4 |
| Upper layer | Inorganic fine particles | Pseudoboehmite | Pseudoboehmite | Pseudoboehmite | Pseudoboehmite |
| | High-boiling solvent | None | DEGMBE | DEGMBE | None |
| | Fine particles of | None | None | None | None |
| | cationic polyurethane | | | | |
| | Basic compound | Ammonia | None | Ammonia | None |
| | Organic compound | None | None | None | None |
| | having sulfo group | | | | |
| | Coating amount of | 19 | 19 | 19 | 19 |
| | pseudoboehmite (g/m²) | | | | |
| Lower layer | Inorganic fine particles | Pseudoboehmite | Pseudoboehmite | Pseudoboehmite | Silica |
| | High-boiling solvent | None | None | None | None |
| | Fine particles of | SUPERFLEX | SUPERFLEX | None | None |
| | cationic polyurethane | 650-5 | 650-5 | | |
| | Zirconium salt | ZIRCOSOL | ZIRCOSOL | None | ZIRCOSOL |
| | | ZA-30 | ZA-30 | | ZA-30 |
| | Coating amount of | 19 | 19 | 19 | 9 |
| | inorganic fine particles | | | | |
| | (g/m²) | | | | |
| Bronzing | | D | D | B | D |
| Print | Y (A820) | 1.60 | 1.60 | 1.65 | 1.64 |
| density | M (A820) | 1.06 | 1.00 | 1.10 | 1.05 |
| | C (A820) | 0.50 | 0.45 | 0.51 | 0.51 |
| | K (A820) | 2.97 | 2.97 | 2.98 | 2.99 |
| | K (C5175) | 2.70 | 2.70 | 2.75 | 2.75 |
| | K (MP950) | 2.75 | 2.75 | 2.80 | 2.80 |
| Bleeding | PM970C | A | A | D | C |
| due to heat | PIXUS 850i | A | A | D | B |
| and | A820 | B | C | C | D |
| moisture | | | | | |
| Ozone | K (C5175) | C | C | C | C |
| resistance | | | | | |
| | | Comparative | Comparative | Comparative | Comparative |
| | | Example 5 | Example 6 | Example 7 | Example 8 |
| Upper layer | Inorganic fine particles | Pseudoboehmite | — | Pseudoboehmite | — |
| | High-boiling solvent | DEGMBE | — | DEGMBE | — |
| | Fine particles of | None | — | SUPERFLEX | — |
| | cationic polyurethane | | | 650-5 | |
| | Basic compound | Ammonia | — | Ammonia | — |
| | Organic compound | None | — | None | — |
| | having sulfo group | | | | |
| | Coating amount of | 38 | 0 | 38 | 0 |
| | pseudoboehmite (g/m²) | | | | |
| Lower layer | Inorganic fine particles | — | Pseudoboehmite | — | Pseudoboehmite |
| | High-boiling solvent | — | None | — | DEGMBE |
| | Fine particles of | — | SUPERFLEX | — | SUPERFLEX |
| | cationic polyurethane | | 650-5 | | 650-5 |
| | Zirconium salt | — | ZIRCOSOL | — | ZIRCOSOL |
| | | | ZA-30 | | ZA-30 |
| | Coating amount of | 0 | 38 | 0 | 38 |
| | inorganic fine particles | | | | |
| | (g/m²) | | | | |
| Bronzing | | B | D | Evaluation | Evaluation |
| Print | Y (A820) | 1.65 | 1.58 | impossible | impossible |
| density | M (A820) | 1.05 | 1.02 | due to | due to |
| | C (A820) | 0.49 | 0.47 | shrinkage | shrinkage |
| | K (A820) | 2.97 | 2.85 | during drying | during drying |
| | K (C5175) | 2.70 | 2.60 | of coating | of coating |
| | K (MP950) | 2.75 | 2.65 | | |
| Bleeding | PM970C | D | A | | |
| due to heat | PIXUS 850i | D | A | | |
| and | A820 | D | B | | |
| moisture | | | | | |
| Ozone | K (C5175) | C | C | | |
| resistance | | | | | |

Explanation of Description in Table 1 to Table 3
DEGMBE . . . diethylene glycol monobutyl ether
TEGMBE . . . triethylene glycol monobutyl ether
DEGMHE . . . diethylene glycol monohexyl ether
“K(C5175)”, “Y(A820)” in the Print Density and Ozone Resistance columns represent “Color (printer name)”.

As shown in Table 1 to Table 3, the inkjet recording media of Example 1 to Example 11, which had the pseudoboehmite alumina, binder, and water-soluble high-boiling solvent in the upper layer and the inorganic fine particles, binder, and cationic polyurethane and/or zirconium salt in the lower layer, had excellent print density and bronzing and bleeding were inhibited. Among these media, the inkjet recording media of Example 8 and Example 9, which had the organic compound having a sulfo group in the upper layer, had an especially high color density and bleeding was inhibited especially effectively. Moreover, these media also excelled in ozone resistance. Furthermore, an especially significant bronzing inhibition effect was demonstrated with inkjet recording media of Examples 1 to 9, which had a high layer ratio of the upper layer as defined by Formula (A) explained in the “DETAILED DESCRIPTION OF THE INVENTION”.

By contrast, in Comparative Example 1 in which no water-soluble high-boiling solvent was contained in the upper layer, Comparative Example 2 in which no basic compound was contained in the upper layer, and Comparative Example 4 in which neither the water-soluble high-boiling solvent nor the basic compound was contained, bronzing worsened. Furthermore, in Comparative Example 3 in which neither the cationic polyurethane nor the zirconium salt was contained in the lower layer, bleeding worsened. Moreover, in Comparative Example 5 in which a single layer of the upper layer coating liquid was coated, bleeding deteriorated, and in Comparative Example 6 in which a single layer of the lower layer coating liquid was coated, bronzing worsened. In Comparative Examples 7 and 8 in which the cationic polyurethane and the water-soluble high-boiling solvent were contained in the same layer, shrinkage occurred during drying of the coating and evaluation was impossible.

All publications, patent applications, and technical standards mentioned in this specification are herein incorporated by reference to the same extent as if each individual publication, patent application, or technical standard was specifically and individually indicated to be incorporated by reference.

What is claimed is:

1. An inkjet recording medium, comprising:
at least two ink-receiving layers on a substrate, wherein:
at least one of the at least two ink-receiving layers comprises a basic compound; and
among the at least two ink-receiving layers, an uppermost layer that is the farthest from the substrate comprises pseudoboehmite alumina, a binder, and a water-soluble high boiling point solvent, and a lower layer provided between the uppermost layer and the substrate comprises inorganic fine particles, a binder, and at least one of a cationic polyurethane or a zirconium salt.

2. The inkjet recording medium according to claim 1, wherein the basic compound is contained in the uppermost layer.

3. The inkjet recording medium according to claim 1, wherein the basic compound is an alcoholamine, a volatile base, an inorganic alkali agent, or a basic amino acid.

4. The inkjet recording medium according to claim 1, wherein the content of the basic compound is 0.01 wt. %-0.3 wt. % in relation to the total amount of solids in all of the at least two ink-receiving layers.

5. The inkjet recording medium according to claim 1, wherein the coating amount of pseudoboehmite alumina in the uppermost layer is 10 g/m²-30 g/m².

6. The inkjet recording medium according to claim 1, wherein the content of pseudoboehmite alumina in the uppermost layer of the ink-receiving layer is 40 wt. %-90 wt. % in relation to the total amount of solids in all ink-receiving layers comprising pseudoboehmite alumina.

7. The inkjet recording medium according to claim 1, wherein inorganic fine particles contained in the lower layer of the ink-receiving layer are fine particle silica, colloidal silica, titanium dioxide, barium sulfate, calcium silicate, zeolite, kaolinite, halloysite, mica, talc, calcium carbonate, magnesium carbonate, calcium sulfate, boehmite alumina, or pseudoboehmite alumina.

8. The inkjet recording medium according to claim 1, wherein the coating amount of the inorganic fine particles in the lower layer is 9 g/m -30 g/m².

9. The inkjet recording medium according to claim 1, wherein the content of the inorganic fine particles in the lower layer of the ink-receiving layer is 0.5 wt. %-10 wt. % in relation to the total amount of solids in all ink-receiving layers comprising the inorganic fine particles.

10. The inkjet recording medium according to claim 1, wherein each of the binder in the uppermost layer of the ink-receiving layer and the binder in the lower layer of the ink-receiving layer is a hydrophilic binder.

11. The inkjet recording medium according to claim 1, wherein each of the binder in the uppermost layer of the ink-receiving layer and the binder in the lower layer of the ink-receiving layer is at least one hydrophilic binder selected from completely or partially saponified poly(vinyl alcohol) and cation-modified poly(vinyl alcohol).

12. The inkjet recording medium according to claim 1, wherein the water-soluble high boiling point solvent in the uppermost layer of the ink-receiving layer is an alcohol.

13. The inkjet recording medium according to claim 1, wherein the water-soluble high boiling point solvent in the uppermost layer of the ink-receiving layer is an ether alcohol.

14. The inkjet recording medium according to claim 1, wherein the content of the water-soluble high boiling point solvent in a coating liquid for the uppermost layer of the ink-receiving layer is 0.05 wt. %-1 wt. %.

15. The inkjet recording medium according to claim 1, wherein a cationic group of the cationic polyurethane is a primary, secondary, or tertiary amine group or a quaternary ammonium group.

16. The inkjet recording medium according to claim 1, wherein the content of a cationic group of the cationic polyurethane is 0.1 mmol/g-5 mmol/g.

17. The inkjet recording medium according to claim 1, wherein the content of the cationic polyurethane in the ink-receiving layer is 0.1 wt. %-30 wt. % in relation to the total amount of solids in the lower layer of the ink-receiving layer comprising the cationic polyurethane.

18. The inkjet recording medium according to claim 1, wherein the content of the zirconium salt is equal to or more than 1 wt. % and less than 30 wt. % in relation to the inorganic fine particles in the lower layer of the ink-receiving layer comprising the zirconium salt.

19. The inkjet recording medium according to claim 1, wherein at least one of the at least two ink-receiving layers comprises an organic compound having a sulfo group.

20. The inkjet recording medium according to claim 19, wherein the organic compound having a sulfo group has a naphthalene ring.

21. A method of producing an inkjet recording medium comprising:
forming an ink-receiving layer by coating at least a coating liquid A comprising inorganic fine particles, a binder, and a cationic polyurethane and/or a zirconium salt and a coating liquid B comprising pseudoboehmite alumina, a binder, and a water-soluble high boiling point solvent on a substrate in the order of the coating liquid A and coating liquid B, as viewed from the substrate side, wherein
at least one coating liquid for forming the ink-receiving layer comprises a basic compound.
